(19) United States
(12) Patent Application Publication
(10) Pub. No.: US 2012/0236410 A1
(43) Pub. Date: Sep. 20, 2012

(54) WIRE-GRID POLARIZER AND PROCESS FOR PRODUCING THE SAME

(75) Inventors: Yosuke Akita, Tokyo (JP); Hiroshi Sakamoto, Tokyo (JP); Yasuhiro Ikeda, Tokyo (JP); Hiromi Sakurai, Tokyo (JP); Yuriko Kaida, Tokyo (JP); Eiji Shidoji, Tokyo (JP)

(73) Assignee: Asahi Glass Company, Limited

(21) Appl. No.: 13/441,674

(22) Filed: Apr. 6, 2012

Related U.S. Application Data
(63) Continuation of application No. PCT/JP2010/067687, filed on Oct. 7, 2010.

(30) Foreign Application Priority Data
Oct. 8, 2009 (JP) 2009-234431

(51) Int. Cl. G02B 5/30; B05D 5/06

(52) U.S. Cl. 359/485.05; 427/163.1

(57) ABSTRACT

A wire-grid polarizer comprising a light-transmitting substrate 14 having a surface on which a plurality of ridges 12 are formed in parallel with one another at a predetermined pitch with flat portions 13 formed between the ridges 12, each of the ridges 12 having a width narrowing from the bottom toward the top; and a metal layer 20 covering at least one side surface of each ridge 12, the maximum covering thickness of the metal layer on a lower half of the ridge being smaller than the maximum covering thickness of the metal layer on an upper half of the ridge; and a process for producing the first metal layer 20 by vapor-depositing a metal from a direction satisfying tan(θ^{R}₁±10)=(Pp−Dpb/2)/Hp on the first side surface 16 side, and subsequently vapor-depositing the metal from a direction at an angle satisfying θ^{R}₁+5≦θ^{R}₂≦θ^{R}₁+25.

### TECHNICAL FIELD

The present invention relates to a wire-grid polarizer and a process for producing the polarizer.

### BACKGROUND ART

As polarizers (they are also referred to as polarizing separation elements) used for image display devices such as liquid crystal display devices, projection TVs or front projectors, and showing polarization separation ability in the visible light region, there are wire-grid polarizers.

A wire-grid polarizer has a construction comprising a light-transmitting substrate having a plurality of parallel fine metallic wires arranged on the substrate. When the pitch of the fine metallic wires is sufficiently shorter than the wavelength of incident light, in the incident light, a component (i.e. p-polarized light) having an electric field vector perpendicular to the fine metallic wires is transmitted, but a component (i.e. s-polarized light) having an electric field vector parallel with the fine metallic wires is reflected.

As wire-grid polarizers showing polarization separation ability in visible light region, the following types are known.

(1) A wire-grid polarizer comprising a light-transmitting substrate on which fine metal wires are formed at a predetermined pitch (refer to Patent Document 1).

(2) A wire-grid polarizer comprising a light-transmitting substrate having a surface on which a plurality of ridges are formed at a predetermined pitch and a top face and side faces of such a ridge is covered with a material film of a metal or a metal compound to form a fine metal wire (refer to Patent Document 2).

(3) A wire-grid polarizer comprising a light-transmitting substrate having a surface on which a plurality of ridges are formed at a predetermined pitch and a plate-shaped member of a metal formed on each ridge as a fine metal wire (refer to Patent Document 4).

(4) A wire-grid polarizer comprising a light-transmitting substrate having a surface on which a plurality of ridges are formed at a predetermined pitch and a metal layer formed on each ridge as a fine metal wire (refer to Patent Document 3).

However, the wire-grid polarizer of (1) has a demerit that its productivity is low since the fine metal wire is formed by lithography.

In the wire-grid polarizers of (2), (3) and (4), reflection of s-polarized light occurs also at an opposite surface side (hereinafter referred to as rear surface side) from a surface side (hereinafter referred to as front surface side) on which the fine metal wires are formed. In a case of a liquid crystal display device, a liquid crystal panel is disposed on the rear surface side of the wire-grid polarizer. Accordingly, when s-polarized light reflected from the rear surface side of the wire-grid polarizer is incident into the liquid crystal panel, the contrast of an image displayed in the liquid crystal panel is deteriorated.

### PRIOR ART DOCUMENTS

### Patent Documents

Patent Document 1: JP-A-2005-070456
Patent Document 2: JP-A-2006-003447
Patent Document 3: JP-A-2005-181990
Patent Document 4: WO 2006/064693

### DISCLOSURE OF INVENTION

### Technical Problem

The present invention provides a wire-grid polarizer having a high degree of polarization, a high p-polarized light transmittance and a low rear surface s-polarized light reflectance, and its production process.

### Solution to Problem

The present invention has the following gists.

(1) A wire-grid polarizer comprising:

a light-transmitting substrate having a surface on which a plurality of ridges are formed in parallel with one another at a predetermined pitch with flat portions formed between the ridges, each of the ridges having a width narrowing from the bottom portion toward the top portion; and

a metal layer comprising a metal or a metal compound and covering at least one side surface of each ridge extending along the longitudinal direction of the ridge, the maximum value of the covering thickness of the metal layer in a region from a half-height position to the bottom portion of the ridge being smaller than the maximum value of the covering thickness of the metal layer in a region from the half-height position to the top portion of the ridge.

(2) The wire-grid polarizer according to (1), which comprises a metal layer comprising a metal or a metal compound and covering two side surfaces of each ridge extending along the longitudinal direction of the ridge, the maximum value of the covering thickness of the metal layer in a region from the half-height position to the bottom portion of each ridge being smaller than the maximum value of the covering thickness of the metal layer in a region from the half-height position to the top portion of the ridge in each of the two side surfaces.
(3) The wire-grid polarizer according to (1) or (2), wherein the cross-sectional shape of each ridge along a section perpendicular to the longitudinal direction is a triangle or a trapezoid.
(4) The wire-grid polarizer according to (1) or (2), wherein provided that the maximum value of the covering thickness of the metal layer in a region from the half-height position to the bottom portion of each ridge is Da1 and the maximum value of the covering thickness of the metal layer in a region from the half-height position to the top portion of the ridge is Dr1, then, a relation Dr1>Da1 is satisfied, Dr1 is from 20 to 80 nm and Da1 is from 4 to 25 nm.
(5) The wire-grid polarizer according to (4), wherein Dr1/Da1 is from 2.5 to 10.
(6) The wire-grid polarizer according to (2), wherein provided that the maximum values of the covering thicknesses of the metal layers on respective two side surfaces of each ridge extending along the longitudinal direction of the ridge, each of which covers a region from the half-height position to the bottom portion of each ridge, are Da1 and Da2, and that the maximum values of the covering thicknesses of the metal layers on the two respective side surfaces, each of which covers a region from the half-height position to the top portion of the ridge, are Dr1 and Dr2, then, relations Dr1>Da1 and Dr2>Da2 are satisfied, Dr1 is from 10 to 45 nm, Dr2 is from 10 to 45 nm, Da1 is from 4 to 25 nm and Da2 is from 4 to 25 nm.
(7) The wire-grid polarizer according to (6), wherein Dr1/Da1 is from 1.5 to 6 and Dr2/Da2 is from 1.5 to 6.
(8) A process for producing a wire-grid polarizer comprising a light-transmitting substrate having a surface on which a plurality of ridges are formed in parallel with one another at a predetermined pitch with flat portions formed between the ridges, each of the ridges having a width narrowing from the bottom portion toward the top portion; and a metal layer comprising a metal or a metal compound and covering at least one side surface of each ridge extending along the longitudinal direction of the ridge;

the process comprising a step (1R1) of carrying out vapor deposition of a metal or a metal compound from a direction substantially perpendicular to the longitudinal direction of each ridge and at an angle θ^{R}₁ (°) satisfying the following formula (a) on a first side surface side to the height direction of the ridge; and

a step (1R2) after the step (1R1), of carrying out vapor deposition of the metal or the metal compound from a direction substantially perpendicular to the longitudinal direction of each ridge and at an angle θ^{R}₂ (°) satisfying the following formula (b) on the first side surface side to the height direction of the ridge under a condition so that the vapor deposition amount becomes larger than that of the step (1R1), to form the metal layer:

tan(θ^{R}₁±10)=(Pp−Dpb/2)/Hp (a)

θ^{R}₁+3≦θ^{R}₂≦θ^{R}₁+30 (b)

where Pp is the pitch of the ridges, Dpb is the width of the bottom portion of each ridge, and Hp is the height of each ridge in formula (a).
(9) The process for producing a wire-grid polarizer according to (8), having a metal layer comprising a metal or a metal compound and covering two side surfaces of each ridge extending along the longitudinal direction of the ridge, the process comprising:

a step (2R1) of carrying out vapor deposition of the metal or the metal compound from a direction substantially perpendicular to the longitudinal direction of each ridge and at an angle θ^{R}₁ (°) satisfying the following formula (c) on the first side surface side to the height direction of the ridge;

a step (2L1) of carrying out vapor deposition of the metal or the metal compound from a direction substantially perpendicular to the longitudinal direction of the ridge and at an angle θ^{L}₁ (°) satisfying the following formula (d) on the second side surface side to the height direction of the ridge;

a step (2R2) after the step (2R1), of carrying out vapor deposition of the metal or the metal compound from a direction substantially perpendicular to the longitudinal direction of the ridge and at an angle θ^{R}₂ (°) satisfying the following formula (e) on the first side surface side to the height direction of the ridge under a condition so that the vapor deposition amount becomes larger than that of the step (2R1); and

a step (2L2) after the step (2L1), of carrying out vapor deposition of the metal or the metal compound from a direction substantially perpendicular to the longitudinal direction of the ridge and at an angle θ^{L}₂ (°) satisfying the following formula (f) on the second side surface side to the height direction of the ridge under a condition so that the vapor deposition amount becomes larger than that of the step (2L1), to form the metal layer:

tan(θ^{R}₁±10)=(Pp−Dpb/2)/Hp (c)

tan(θ^{L}₁±10)=(Pp−Dpb/2)/Hp (d)

θ^{R}₁+3≦θ^{R}₂≦θ^{R}₁+20 (e)

θ^{L}₁+1≦θ^{L}₂≦θ^{L}₁+20 (f)

where Pp is the pitch of the ridges, Dpb is the width of the bottom portion of each ridge, and Hp is the height of each ridge in formulae (c) and (d).
(10) The process for producing a wire-grid polarizer according to (8), wherein the step (1R1) is carried out under a condition whereby the vapor deposition amount becomes 4 to 25 nm, and the step (1R2) is carried out under a condition whereby the vapor deposition amount becomes 25 to 70 nm.
(11) The process for producing a wire-grid polarizer according to (9), wherein the step (2R1) and the step (2L1) are carried out under conditions whereby the vapor deposition amounts become 4 to 25 nm, and the step (2R2) and the step (2L2) are carried out under conditions whereby the vapor deposition amounts become 10 to 25 nm.
(12) The process for producing a wire-grid polarizer according to (8) or (9), wherein each ridge comprises a photocurable resin or a thermoplastic resin and is formed by an imprint method.

In this specification “from . . . to . . . ” means a range including the front and rear values as a lower limit value and an upper limit value, respectively, unless otherwise specified.

### Advantageous Effects of Invention

The wire-grid polarizer of the present invention has a high degree of polarization, a high p-polarized light transmittance and a low rear surface s-polarized light reflectance.

By the process for producing a wire-grid polarizer of the present invention, it is possible to produce a wire-grid polarizer having a high degree of polarization, a high p-polarized light transmittance and a low rear surface s-polarized light reflectance with high productivity.

### BRIEF DESCRIPTION OF DRAWINGS

FIG. 1 is a perspective view showing an example of the wire-grid polarizer of the present invention.

FIG. 2 is a perspective view showing another example of the wire-grid polarizer of the present invention.

FIG. 3 is a perspective view showing another example of the wire-grid polarizer of the present invention.

FIG. 4 is a perspective view showing an example of light-transmitting substrate.

### DESCRIPTION OF EMBODIMENTS

### <Wire-Grid Polarizer>

The wire-grid polarizer of the present invention is a wire-grid polarizer comprising:

a light-transmitting substrate having a surface on which a plurality of ridges are formed in parallel with one another at a predetermined pitch with flat portions formed between the ridges, each of the ridges having a width narrowing from the bottom portion toward the top portion; and

a metal layer comprising a metal or a metal compound and covering at least one side surface of each ridge extending along the longitudinal direction of the ridge, the maximum value of the covering thickness of the metal layer in a region from a half-height position to the bottom portion of the ridge being smaller than the maximum value of the covering thickness of the metal layer in a region from the half-height position to the top portion of the ridge.

### (Light-Transmitting Substrate)

The light-transmitting substrate is a substrate having a light-transmittance in a wavelength region to be used for the wire-grid polarizer. The light-transmittance means a property of transmitting light, and the wavelength region is specifically a region of from 400 nm to 800 nm. The light-transmitting substrate is preferably one having an average light-transmittance of at least 85% in a region of from 400 nm to 800 nm.

In the present invention, each of the ridges is a portion projecting from a principal surface of the light-transmitting substrate, which extends in one direction. The ridges may be made of the same material as the material of the surface portion of the light-transmitting substrate and integrally formed with the portion, or it may be made of a light-transmitting material different from the material of the principal surface portion of the light-transmitting substrate. The ridges are preferably integrally formed with the principal surface of the light-transmitting substrate and made of the same material as the principal surface portion of the light-transmitting substrate. Further, the ridges are preferably formed by shaping at least the principal surface portion of the light-transmitting substrate.

It is sufficient that the plurality of ridges are formed so that corresponding side faces of the ridges are substantially parallel and they are not necessary formed completely in parallel. Further, each ridge preferably has a linear shape in plan view which is the optimum shape for developing optical anisotropy, but each ridge may have a curve shape or a polygonal line shape so long as adjacent ridges do not contact to each other.

The cross-sectional shape of each ridge in a section perpendicular to the longitudinal direction of the ridge and the principal plane of the light-transmitting substrate, is preferably constant along the longitudinal direction of the ridge, and the cross-sectional shape is preferably substantially constant among a plurality of the ridges. The cross-sectional shape is preferably a shape having a width narrowing from a bottom portion (that is the principal surface of the light-transmitting substrate) toward the top portion. A specific cross-sectional shape may, for example, be a triangle, a trapezoid or a rectangle. In the cross-sectional shape, a corner or a side (side surface) may be curved. Further, the width of each space between the plurality of ridges formed in parallel or substantially in parallel on the surface of the light-transmitting substrate, that is the width of each flat portion, may be constant or it may be a different predetermined width in one part or over the entire region.

Since the cross-sectional shape of each ridge is a shape having a width narrowing from the bottom portion toward the top portion, as compared with a case where the cross-sectional shape of each ridge is rectangle, it is possible to obtain a sufficient interval between ridges after formation of a metal layer, and to achieve high p-polarized light transmittance.

In the present invention, the top portion of a ridge means a portion that is the highest portion in the cross-sectional shape and that continues in the longitudinal direction of the ridge. The top portion of the ridge may be a plane or a line. For example, when the cross-sectional shape is a trapezoid, the top portion is a plane, and when the cross-sectional shape is a triangle, the top portion is a line. In the present invention, surfaces other than the top portion of a ridge are referred to as side faces of ridge. Here, a face between two adjacent ridges (that is a bottom face of a groove between two ridges) is not referred to as a surface of the ridges, but is referred to as a principal surface of the light-transmitting substrate.

The raw material or the material of the light-transmitting substrate may, for example, be a photocurable resin, a thermoplastic resin or a glass, and it is preferably a photocurable resin or a thermoplastic resin from the viewpoint of capability of forming the ridges by an imprint method to be described later, and it is particularly preferably a photocurable resin from the viewpoint of capability of forming the ridges by a photoimprint method and from the viewpoint of excellence in the thermal resistance and durability. The photocurable resin is preferably a photocurable resin obtainable by photocuring of a photocurable composition that is photocurable by photo-radical polymerization, from the viewpoint of productivity.

The photocurable composition is preferably one which shows a contact angle of at least 90° with water after the composition is photocured to form a cured film. When such a cured film has a contact angle of at least 90° with water, at a time of forming the ridges by a photoimprint method, it is possible to improve a releasing property from a mold, and to achieve a transcription with high accuracy, and to sufficiently exhibit the objective performance of the wire-grid polarizer to be obtained. Further, even if the contact angle is high, there is no problem in adhesion of the metal layer.

### (Metal Wire)

The metal layer present on each ridge has a strip shape extending in the longitudinal direction of the ridge and having a predetermined width, which corresponds to a metal wire constituting a wire-grid polarizer.

The metal layer covers at least one side surface extending along the longitudinal direction of each ridge, and the maximum value of the covering thickness in a region from a half-height position to the bottom portion of the ridge, is smaller than the maximum value of covering thickness in a region from the half-height position to the top portion of the ridge. It is considered that a metal layer covering a region from the half-height position to the top portion of the ridge contributes to improvement of the front surface s-polarized light reflectance, and a metal layer covering a region from the half-height position to the bottom portion of the ridge contributes to lowering of the rear surface s-polarized light reflectance.

The metal layer preferably covers the entire portion of at least one side surface extending along the longitudinal direction of each ridge in order to lower the rear surface s-polarized light reflectance.

The metal layer may cover a part or all of the top portion of each ridge. Further, the metal layer may cover a part of flat portion adjacent to at least one side surface extending along the longitudinal direction of the ridge.

A metal layer covering the side surface of each ridge is usually continuous. At least one side surface extending along the longitudinal direction of the ridge is preferably continuously covered by the metal layer, but due to e.g. a problem in production, there is a case where a small portion of side surfaces is not covered by the metal layer. Even in such a case, when at least one side surface is almost continuously covered by the metal layer, it is regarded that at least one side surface is continuously covered by the metal layer.

The wire-grid polarizer of the present invention preferably has a metal layer covering two side surfaces extending along the longitudinal direction of each ridge, that is made of a metal or a metal compound, wherein in each of two side surfaces, the maximum value of the covering thickness in a region from a half-height position to the bottom portion of the ridge, is smaller than the covering thickness in a region from the half-height position to the top portion of the ridge.

When a metal layer wherein the maximum value of the covering thickness in a region from the half-height position to the bottom portion of the ridge, is smaller than the maximum value of the covering thickness in a region from the half-height position to the top portion of the ridge, is formed not only on one side surface of the ridge but on each side surface, the s-polarized light transmittance is suppressed and the extinction ratio is improved.

It is sufficient that the material of the metal layer is a metal material having a sufficient electric conductivity, and is preferably a material selected by considering properties such as corrosion resistance. As the metal material, a metal or a metal compound is mentioned.

As the material of the metal layer, from the viewpoint of high reflectance for visual light, low absorptance of visual light and high electric conductivity, aluminum, an aluminum alloy, silver, a silver alloy, chromium, a chromium alloy, magnesium, a magnesium alloy, etc. is preferred, and aluminum or an aluminum alloy is particularly preferred.

### <Process for Producing a Wire-Grid Polarizer>

The wire-grid polarizer of the present invention is produced by preparing a light-transmitting substrate having a surface on which a plurality of ridges are formed in parallel with one another at a predetermined pitch, and subsequently forming the metal layer so that the maximum value of the covering thickness of the metal in a region from a half-height position to the bottom portion of each ridge, is smaller than the maximum value of the covering thickness of the metal layer in a region from the half-height position to the top portion of the ridge.

### (Preparation of Light-Transmitting Substrate)

The process for producing the light-transmitting substrate may, for example, be an imprinting method (photoimprinting method or thermoimprinting method) or a lithography method. From the viewpoint of productivity in forming the ridges and capability of producing a light-transmitting substrate having a large area, the process is preferably an imprinting method, and from the viewpoint of high productivity in producing the ridges and capability of transferring the shape of grooves of a mold with high precision, the process is particularly preferably a photoimprinting method.

The photoimprinting method is, for example, be a method of preparing a mold in which a plurality of grooves are formed in parallel with one another at a predetermined pitch by a combination of electron beam lithography and etching, transcripting the shape of the grooves of the mold into a photocurable composition applied on a surface of an optional substratum, and photocuring the photocurable composition at the same time.

The preparation of light-transmitting substrate by the photoimprinting method is preferably specifically carried out through the following steps (i) to (iv).

(i) A step of applying a photocurable composition on a surface of a substratum.

(ii) A step of pressing a mold in which a plurality of grooves are formed so as to be parallel with one another at a predetermined pitch, against the photocurable composition so that the grooves contact with the photocurable composition.

(iii) A step of radiating a radiation (UV rays, electron beams, etc.) to the mold in a state that the mold is pressed against the photocurable composition, to cure the photocurable composition to produce a light-transmitting substrate having a plurality of ridges corresponding to the grooves of the mold.

(iv) A step of separating the mold from the light-transmitting substrate.

Here, on the obtained light-transmitting substrate on the substratum, it is possible to form the metal layer to be described later while the substrate is integrally combined with the substratum. Further, as the case requires, the light-transmitting substrate and the substratum may be separated after formation of the metal layer. Further, it is possible to form the metal layer to be described later, after the light-transmitting substrate formed on the substratum is separated from the substratum.

The preparation of light-transmitting substrate by a thermoimprinting method is preferably specifically carried out through the following steps (i) to (iii).

(i) A step of forming on a surface of a substratum a layer of thermoplastic resin to which a pattern is to be transcripted, or a step of producing a film of thermoplastic resin to which a pattern is to be transcripted.

(ii) A step of pressing a mold in which a plurality of grooves are formed so as to be parallel with one another at a predetermined pitch, against the layer to be transcripted or the film to be transcripted, so that the grooves contact with the layer to be transcripted or the film to be transcripted, in a state that they are heated to be at least the glass transition temperature (Tg) or the melting point (Tm) of the thermoplastic resin, to prepare a light-transmitting substrate having a plurality of ridges corresponding to the grooves of the mold.

(iii) A step of cooling the light-transmitting substrate to a temperature lower than Tg or Tm and separating the mold from the light-transmitting substrate.

Here, on the obtained light-transmitting substrate on the substratum, it is possible to form the metal layer to be described later while the substrate is integrally combined with the substratum. Further, as the case requires, the light-transmitting substrate and the substratum may be separated after formation of the metal layer. Further, it is possible to form the metal layer to be described later, after the light-transmitting substrate formed on the substratum is separated from the substratum.

The material of the mold to be employed for the imprint method may be silicon, nickel, quartz, a resin, etc., and from the viewpoint of transcription accuracy, a resin is preferred. As the resin, a fluororesin (such as an ethylene-tetrafluoroethylene copolymer), a cyclic olefin, a silicone resin, an epoxy resin or an acrylic resin may, for example, be mentioned. From the viewpoint of accuracy of mold, a photocurable acrylic resin is preferred. Such a resin mold preferably has an inorganic film having a thickness of from 2 to 10 nm formed on the surface from the viewpoint of durability against repeated transcription. As the inorganic film, an oxide film such as SiO₂, TiO₂ or Al₂O₃ is preferred.

### (Formation of Metal Layer)

The metal layer is preferably formed by a vapor deposition method. As the vapor deposition method, a physical vapor deposition method (PVD) or a chemical vapor deposition method (CVD) are mentioned, and the vapor deposition method is preferably a vacuum vapor deposition method, a sputtering method or an ion plating method, particularly preferably a vacuum vapor deposition method. In the vacuum vapor deposition method, it is easy to control incident direction of adhering fine particles in relation to the light-transmitting substrate, and it is easy to carry out an oblique vapor deposition method to be described later. In the formation of the metal layer, since it is necessary to selectively vapor-deposit a metal or a metal compound to form the metal layer so that the maximum value of the covering thickness in a region from a half-height position to the bottom portion of each ridge is smaller than the maximum value of the covering thickness in a region from the half-height position to the top portion of the ridge, an oblique vapor deposition method using the vacuum vapor deposition method is the most preferred.

Specifically, the present invention employs a step (1R1) of vapor-depositing a metal or a metal compound from a direction substantially perpendicular to the longitudinal direction of the ridges and at an angle θ^{R}₁ (°) satisfying the following formula (a) on the first side surface side to the height direction of each ridge, and after the step (1R1), a step (1R2) of vapor-depositing a metal or a metal compound from a direction substantially perpendicular to the longitudinal direction of ridges and at an angle θ^{R}₂ (°) satisfying the following formula (b) on the first side surface side to the height direction of each ridge, under a condition so that the vapor-deposition amount becomes larger than that of the step (1R1), whereby an objective metal layer is formed.

tan(θ^{R}₁±10)=(Pp−Dpb/2)/Hp (a)

θ^{R}₁+3≦θ^{R}₂≦θ^{R}₁+30 (b)

In the formula (a), Pp represents the pitch of the ridges, Dpb represents the width of the bottom portion of each ridge, and Hp represents the height of each ridge.

In this specification, θ±10 means a region of at least (θ−10) and at most (θ+10). This definition is applied to other similar description.

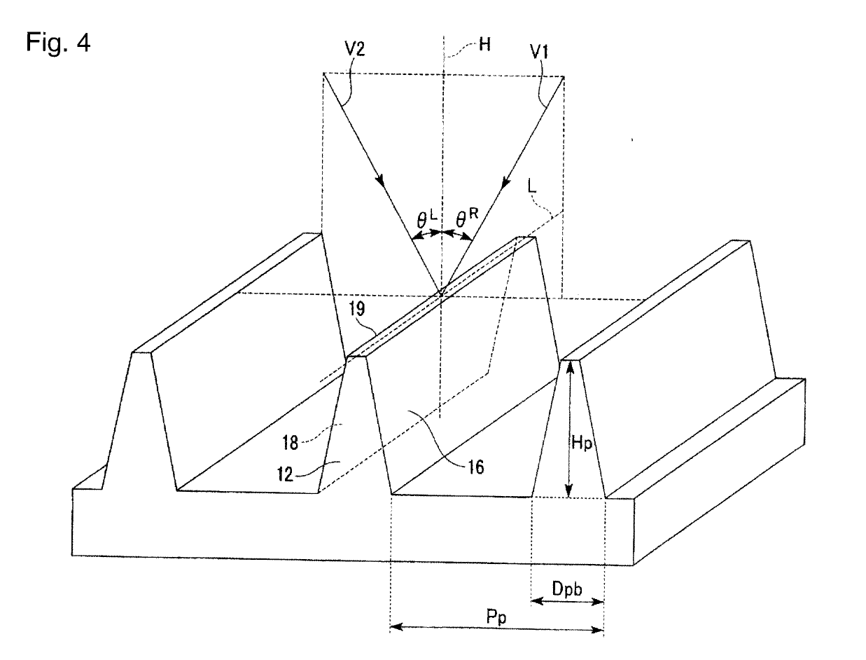

In this specification, “substantially perpendicular” means that an angle between a direction L and a direction V1 (or V2) is within a range of from 85 to 95°. (Here, with respect to the direction L, the direction V1 and the direction V2, refer to FIG. 4.)

The vapor deposition amount means the thickness of a metal layer formed by vapor deposition of a metal or a metal compound on a surface of a region where no ridge is formed (that is a flat plate portion) at a time of forming a metal layer on ridges.

Further, in a case of forming a metal layer made of a metal or a metal compound covering two side surfaces extending along the longitudinal direction of each ridge, the present invention employs a step (2R1) of vapor-depositing the metal or the metal compound from a direction substantially perpendicular to the longitudinal direction of the ridge and at an angle θ^{R}₁ (°) satisfying the following formula (c) on the first side surface side to the height direction of the ridge; a step (2L1) of vapor-depositing the metal or the metal compound from a direction substantially perpendicular to the longitudinal direction of the ridge and at an angle θ^{L}₁ (°) satisfying the following formula (d) on the second side surface side to the height direction of the ridge; and subsequent to the step (2R1), a step (2R2) of vapor-depositing the metal or the metal compound from a direction substantially perpendicular to the longitudinal direction of the ridge and at an angle θ^{R}₂ (°) satisfying the following formula (e) on the first side surface side to the height direction of the ridge under a condition so that the vapor-deposition amount becomes larger than that of the step (2R1); and subsequently to the step (2L1), a step (2L2) of vapor-depositing the metal or the metal compound from a direction substantially perpendicular to the longitudinal direction of the ridge and at an angle θ^{L}₂ (°) satisfying the following formula (f) on the second side surface side to the height direction of the ridge under a condition so that the vapor-deposition amount becomes larger than that of the step (2L1), to form a metal layer, whereby an objective metal layer is formed.

tan(θ^{R}₁+10)=(Pp−Dpb/2)/Hp (c)

tan(θ^{L}₁±10)=(Pp−Dpb/2)/Hp (d)

θ^{R}₁+3≦θ^{R}₂≦θ^{R}₁+20 (e)

θ^{L}₁+1≦θ^{L}₂≦θ^{L}₁+20 (f)

In the formula (c) and the formula (d), Pp represent the pitch of the ridges, Dpb represents the width of the bottom portion of each ridge, and Hp represents the height of each ridge.

### <Wire-Grid Polarizer of Each Embodiment>

Wire-grid polarizers of the present invention are described below with reference to drawings. The drawings are schematic views, and an actual wire-grid polarizer does not have the logical and ideal shape as shown in these drawings. For example, there is a considerable degree of deformation in the shape of e.g. each ridge and there is also a considerable amount of unevenness of the thickness of the metal layer.

Here, dimensions of the ridge and the metal layer of the present invention are each obtained by measuring the dimension of the ridge or the dimension of metal layer on the ridge with respect to five ridges in a scanning electron microscopic image or a transmission electron microscopic image of a cross-section of the wire-grid polarizer, and averaging the five dimensions.

### First Embodiment

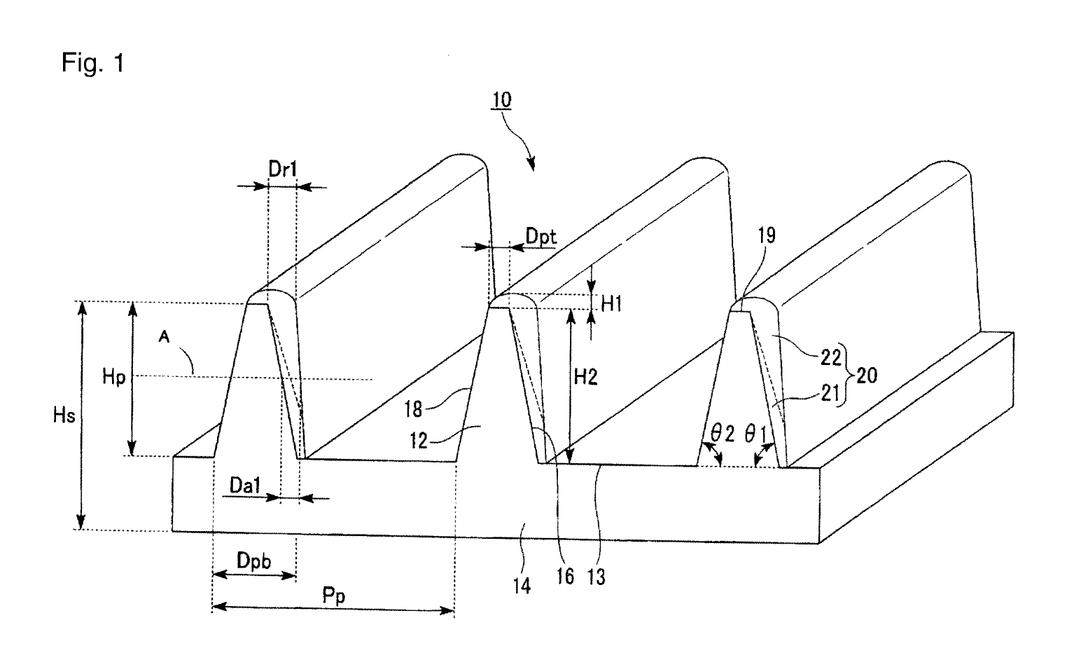

FIG. 1 is a perspective view showing a first embodiment of the wire-grid polarizer of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; and a first metal layer 20 made of a metal or a metal compound and covering a first side surface 16 of each ridge 12, which is a first metal layer wherein the maximum value of the covering thickness in a region from a half-height position (indicated by the dotted line A in FIG. 1) to the bottom portion of each ridge 12, is smaller than the maximum value of the covering thickness in a region from the half-height position to the top portion 19 of the ridge 12. The first metal layer 20 extends in the longitudinal direction of each ridge 12 to constitute a fine metal wire.

### (Light-Transmitting Substrate)

Pp is a sum total of the width Dpb of the bottom portion of each ridge 12 and the width of each flat portion 13 formed between the ridges 12. Pp is preferably at most 300 nm, more preferably from 50 to 250 nm. When Pp is at most 300 nm, the wire-grid polarizer shows a high front surface s-polarized light reflectance and shows a high degree of polarization in a short wavelength region of about 400 nm. Further, coloring due to refraction can be suppressed. Further, when Pp is from 50 to 200 nm, it is easy to form each layer by vapor deposition.

The ratio (Dpb/Pp) between Dpb and Pp is preferably from 0.1 to 0.7, more preferably from 0.25 to 0.55. When Dpb/Pp is at least 0.1, the wire-grid polarizer shows a high degree of polarization. When Dpb/Pp is at most 0.7, coloring of transmission light due to interference can be suppressed.

Dpb is preferably from 30 to 100 nm from the viewpoint of easiness of formation of each layer by vapor deposition.

The width Dpt of a top portion 19 of each ridge 12 is preferably at most a half of Dpb, more preferably at most 40 nm, still more preferably at most 20 nm. When Dpt is at most a half of Dpb, the p-polarized light transmittance becomes further higher and its angle dependence becomes sufficiently low.

The height Hp of the ridge 12 is preferably from 120 to 1,000 nm. When Hp is at least 120 nm, polarized light separation ability becomes sufficiently high. When Hp is at most 1,000 nm, it is easy to form the ridge 12.

The height Hp of the ridge 12 is preferably from 250 to 1,000 nm from the viewpoint of contrast when the wire-grid polarizer is employed for an image display device. From the viewpoint of suppressing lowering of contrast when the device is observed from a diagonal direction, Hp is more preferably from 250 to 400 nm.

The height Hp of the ridge 12 is particularly preferably from 120 to 300 nm from the viewpoint of reducing wavelength dispersion.

Further, when Hp is from 80 to 270 nm, it is easy to form the first metal layer 20 by vapor deposition.

A slope angle θ₁ of the first side surface 16 to the principal surface of the light-transmitting substrate corresponding to its flat portion, and a slope angle θ₂ of the second side surface 18 to the principal surface of the light-transmitting substrate corresponding to its flat portion, are preferably 30 to 80°. θ₁ and θ₂ may be the same or different. More preferably, each of θ₁ and θ₂ is from 45 to 80°.

The thickness Hs of the light-transmitting substrate 14 is preferably from 0.5 to 1,000 μm, more preferably from 1 to 40 μm.

### (First Metal Layer)

The maximum value Dr1 of the covering thickness (thickness in the width direction of ridge 12) of the first metal layer 20 covering a region from a half-height position to the top portion 19 of each ridge 12 (upper half of ridge 12; portion above the dotted line A in FIG. 1.) is preferably from 20 to 80 nm. It is preferably from 20 to 75 nm, more preferably from 35 to 55 nm, particularly preferably from 40 to 50 nm. When Dr1 is at least 20 nm, the front surface s-polarized light reflectance becomes sufficiently high. When Dr1 is at most 80 nm, the p-polarized light transmittance becomes sufficiently high.

The maximum value Da1 of the covering thickness (thickness in the width direction of ridge 12) of the first metal layer 20 covering a region from a half-height position to the bottom portion of the ridge 12 (lower half of ridge 12), is preferably from 4 to 25 nm, more preferably from 5 to 22 nm. When Da1 is at least 4 nm, the rear surface s-polarized light reflectance becomes sufficiently low. When Da1 is at most 25 nm, the p-polarized light transmittance becomes sufficiently high.

The maximum value Dr1 of the covering thickness covering a region from the half-height position to the top portion 19 of the ridge 12 (upper half of ridge 12) preferably satisfies the following formula (m₁).

0.2×(Pp−Dpb)≦Dr1≦0.95×(Pp−Dpb) (m₁)

When Dr1 is at least 0.2×(Pp−Dpb), s-polarized light transmittance becomes low, polarized light separation ability becomes sufficiently high and its wavelength dispersion is small. When Dr1 is at most 0.95×(Pp−Dpb), the wire-grid polarizer shows a high p-polarized light transmittance.

The ratio (Dr1/Da1) of the maximum value Dr1 of the covering thickness covering a region from the half-height position to the top portion of the ridge 12 (upper half of the ridge 12) based on the maximum value Da1 of the covering thickness covering from the half-height position to the bottom portion of the ridge 12 (lower half of the ridge 12, which is a portion lower than the dotted line A in FIG. 1), is preferably from 2.5 to 10, more preferably from 3 to 8. When Dr1/Da1 is at least 2.5, polarized light separation ability becomes sufficiently high and its wavelength dispersion is small. When Dr1/Da1 is at most 10, the wire-grid polarizer shows a high p-polarized light transmittance.

With respect to the height H2 of a first metal layer 20 present below (light-transmitting substrate 14 side) of the top portion 19 of the ridge 12, H2/Hp is preferably from 0.8 to 1, more preferably from 0.9 to 1. When H2/Hp is at most 1, polarized light separation ability becomes high. When H2/Hp is at least 0.8, rear surface s-polarized light reflectance becomes sufficiently low.

With respect to the height H1 of the first metal layer 20 present above (far side from the light-transmitting substrate 14) the top portion 19 of the ridge 12, H1/Hp is preferably from 0.05 to 0.7, more preferably from 0.1 to 0.5. When H1/Hp is at most 0.7, rear surface s-polarized light reflectance becomes sufficiently low. When H1/Hp is at least 0.05, front surface s-polarized light reflectance becomes sufficiently high.

### Second Embodiment

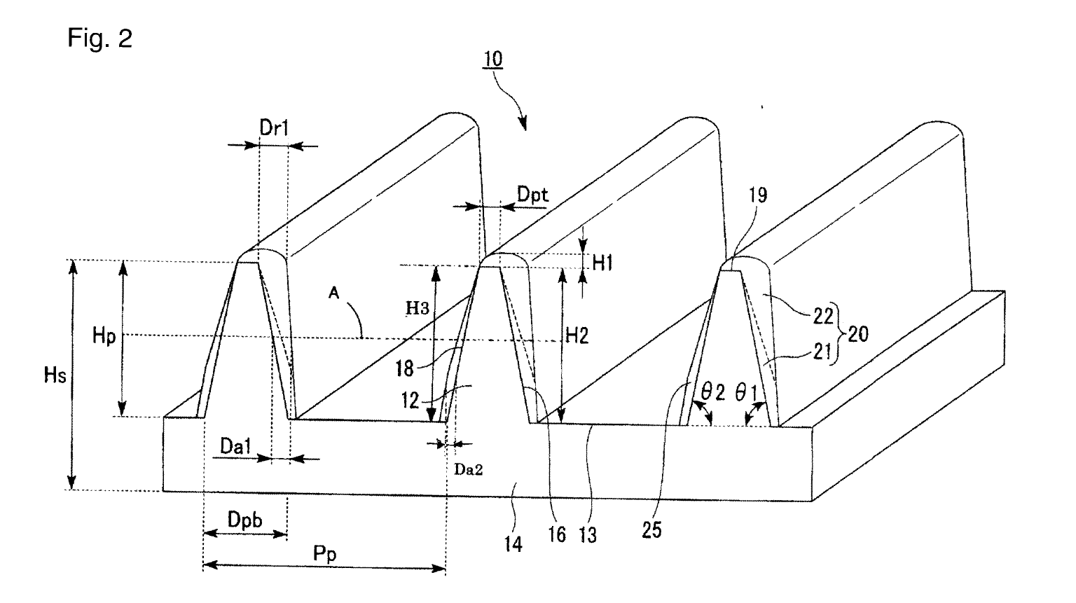

FIG. 2 is a perspective view showing a second embodiment of the wire-grid polarizer of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a first metal layer 20 made of a metal or a metal compound and covering a first side surface 16 of each ridge 12, which is a first metal layer wherein the maximum value of the covering thickness in a region of from a half-height position (indicated by the dotted line A in FIG. 2) to the bottom portion of each ridge 12, is smaller than the maximum value of the covering thickness in a region of from the half-height position to the top portion 19 of the ridge 12; and a second metal layer 25 made of a metal or a metal compound covering a second side surface 18 of the ridge 12.

In the second embodiment, the rear surface s-polarized light reflectance is lower than that of the first embodiment.

In the second embodiment, explanations of constructions common to the wire-grid polarizer 10 of the first embodiment are omitted.

### (Second Metal Layer)

The maximum value Da2 of the thickness of the second metal layer 25 in the width direction of each ridge 12 is preferably from 4 to 25 nm, more preferably from 5 to 22 nm. When Da2 is at least 4 nm, the rear surface s-polarized light reflectance becomes sufficiently low. When Da2 is at most 25 nm, the p-polarized light transmittance becomes sufficiently high.

With respect to the height H3 of the second metal layer 25 (height of the second metal layer 25 below the top portion of the ridge 12, that is, present below the position indicated by the dotted line A in FIG. 2), H3/Hp is preferably from 0.8 to 1, more preferably from 0.9 to 1. When H3/Hp is at most 1, the polarized light separation ability becomes high. When H3/Hp is at least 0.8, the rear surface s-polarized light reflectance becomes sufficiently low.

### Third Embodiment

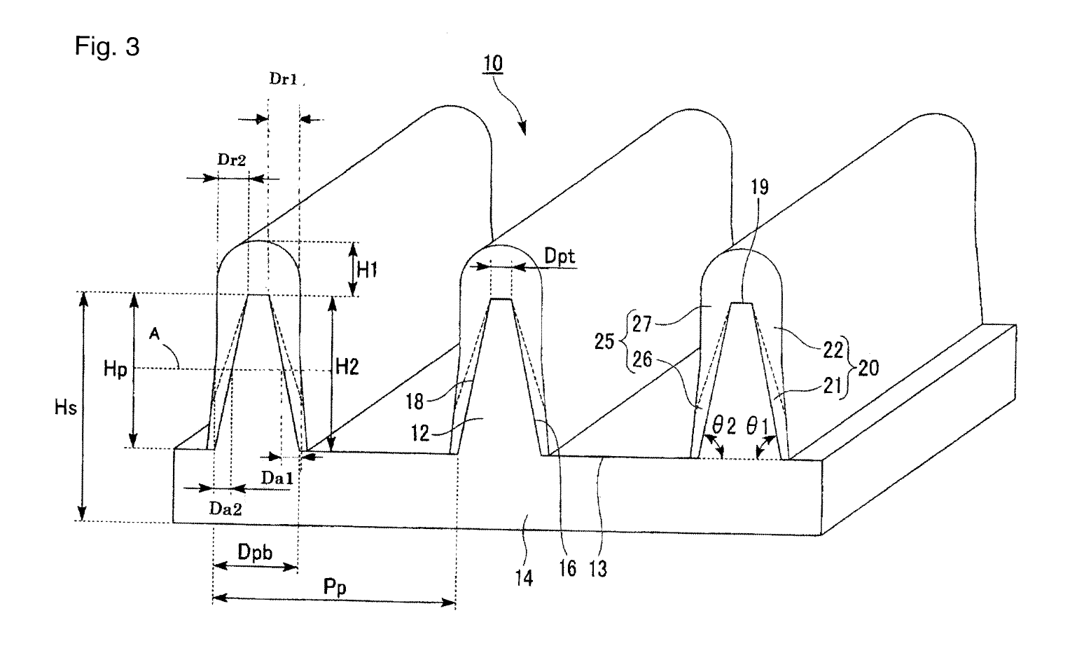

FIG. 3 is a perspective view showing a third embodiment of the wire-grid polarizer of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a first metal layer 20 made of a metal or a metal compound and covering a first side surface 16 of each ridge 12, which is a first metal layer wherein the maximum value of the covering thickness in a region from a half-height position (indicated by the dotted line A in FIG. 3) to the bottom portion of each ridge 12, is smaller than the maximum value of the covering thickness in a region from the half-height position to the top portion 19 of the ridge 12; and a second metal layer 25 made of a metal or a metal compound covering a second side surface 18 of the ridge 12, wherein the maximum value of the covering thickness in a region from the half-height position (position indicated by the dotted line A in FIG. 3) to the bottom portion of the ridge 12 is smaller than the maximum value of the covering thickness in a region from the half-height position to the top portion 19 of the ridge 12.

In the third embodiment, the rear surface s-polarized light reflectance is lower than those of the first and second embodiments.

In the third embodiment, explanations of the constructions common to the wire-grid polarizers 10 of the first and second embodiments are omitted.

### (First Metal Layer)

The maximum value Dr1 of the covering thickness of the first metal layer 20 (thickness in the width direction of the ridge 12) covering a region of from a half-height position to the top portion 19 of each ridge 12 (upper half of ridge 12, that is a portion above the dotted line in FIG. 3), is preferably at most 50 nm. It is preferably from 10 to 45 nm, more preferably from 15 to 35 nm. When Dr1 is at least 10 nm, the front surface s-polarized light reflectance becomes sufficiently high. When Dr1 is at most 50 nm, the p-polarized light transmittance becomes sufficiently high.

A preferred embodiment of the maximum value Da1 of the covering thickness of the first metal layer 20 (thickness in the width direction of the ridge 12) covering a region from the half-height position to the bottom portion of the ridge 12 (lower half of the ridge 12, that is a portion below the dotted line A in FIG. 3), is similar to that of the first embodiment, and it is preferably from 4 to 25 nm, more preferably from 5 to 22 nm. When Da1 is at least 4 nm, the rear surface s-polarized light reflectance becomes sufficiently low. When Da1 is at most 25 nm, the p-polarized light transmittance becomes sufficiently high.

The maximum value Dr1 of the covering thickness in a region from the half-height position to the top portion 19 of the ridge 12 (upper half of the ridge 12) preferably satisfies the following formula (m₂).

0.2×(Pp−Dpb)≦Dr1≦0.5×(Pp−Dpb) (m₂)

When Dr1 is at least 0.2×(Pp−Dpb), s-polarized light transmittance becomes low, polarized light separation ability becomes sufficiently high and its wavelength dispersion is small. When Dr1 is at most 0.5×(Pp−Dpb), the wire-grid polarizer shows a high p-polarized light transmittance.

The ratio (Dr1/Da1) of the maximum value Dr1 of the covering thickness in a region from the half-height position to the top portion of the ridge 12 (upper half of the ridge 12) based on the maximum value Da1 of the covering thickness in a region from the half-height position to the bottom portion of the ridge 12 (lower half of the ridge 12), is preferably from 1.5 to 6, more preferably from 2 to 4. When Dr1/Da1 is at least 1.5, polarized light separation ability becomes sufficiently high and its wavelength dispersion is small. When Dr1/Da1 is at most 6, the wire-grid polarizer shows a high p-polarized light transmittance.

With respect to the height H2 of the first metal layer 20 present below the top portion 19 of the ridge 12, H2/Hp is preferably from 0.8 to 1, more preferably from 0.9 to 1. When H2/Hp is at most 1, polarized light separation ability becomes high. When H2/Hp is at least 0.8, rear surface s-polarized light reflectance becomes sufficiently low.

With respect to the height H1 of the first metal layer 20 present above the top portion 19 of the ridge 12, H1/Hp is preferably from 0.05 to 0.7, more preferably from 0.1 to 0.5. When H1/Hp is at most 0.7, rear surface s-polarized light reflectance becomes sufficiently low. When H1/Hp is at least 0.05, front surface s-polarized light reflectance becomes sufficiently high.

A preferred embodiment of the second metal layer 25 is similar to the preferred embodiment of the first metal layer 20.

In the explanation of FIGS. 1 to 3 of the wire-grid polarizers of the first to third embodiments of the present invention described above, explanations have been made based on an example wherein the right side surface of the ridge is designated as the first side surface of the ridge and the first metal layer 20 is formed on the first side surface 16, and in FIGS. 2 and 3, the explanations have been made based on an example wherein the right side surface of the ridge is designated as the first side surface 16 of the ridge, the first metal layer 20 is formed on the first side surface 16, the left side surface of the ridge is designated as the second side surface 18 of the ridge, and the second metal layer 25 is formed on the second side surface 18. However, it is of course possible to swap the first side surface and the second side surface of the ridge in the explanation, and to designate the left side surface of the ridge as the first side surface of the ridge and the right side surface of the ridge as the second side surface of the ridge in each drawing.

Here, as described above, even if the first and the second side surfaces on left and right sides of the ridge extending along the longitudinal direction are swapped in the explanation, with respect to the covering thickness of metal layers covering respective side surfaces, the feature that the maximum value of the covering thickness in a region from a half-height position to the bottom portion of the ridge, is smaller than the maximum value of the covering thickness in a region from the half-height position to the top portion of the ridge, is similarly required.

Further, in the same manner, also in the process for producing a wire-grid polarizer of the present invention, it is possible to designate a right side surface of each ridge as the first side surface and a left side surface as the second side surface. Further, it is possible to designate a left side surface of each ridge as the first side surface and the right side surface as the second side surface.

### <Process for Producing Wire-Grid Polarizer of Each Embodiment>

### [Process for Producing Wire-Grid Polarizer of First Embodiment]

The wire-grid polarizer 10 of the first embodiment can be produced by carrying out a step (1R1) of forming a lower layer 21 of a first metal layer on a first side surface 16 of each ridge 12 of a light-transmitting substrate 14, and after the step (1R1), a step (1R2) of forming an upper layer 22 of the first metal layer on the first side surface 16 of the ridge 12 and/or on a surface of the lower layer 21 of the first metal layer.

As the vapor deposition source, a metal layer (aluminum, silver, magnesium, chromium, an aluminum alloy, a silver alloy, a magnesium alloy, a chromium alloy, etc.) is mentioned, and from the viewpoint of high reflectance for visual light, low absorptance of visual light and high electric conductivity, aluminum, an aluminum alloy, silver or magnesium is preferred, and aluminum or an aluminum alloy is particularly preferred.

### (Formation of Lower Layer of First Metal Layer)

The lower layer 21 of the first metal layer can be formed, as shown in FIG. 4, by carrying out a step (1R1) of vapor-depositing a metal or a metal compound from a direction V1 substantially perpendicular to the longitudinal direction of each ridge 12 and at an angle θ^{R}₁ (°) satisfying the following formula (a) on the first side surface 16 side to the height direction H of the ridge 12.

tan(θ^{R}₁±10)=(Pp−Dpb/2)/Hp (a)

The angle θ^{R}₁ (°) preferably satisfies an equation tan(θ^{R}₁±7)=(Pp−Dpb/2)/Hp, more preferably satisfies an equation tan(θ^{R}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. The vapor deposition may be carried out while continuously changing the angle θ^{R}₁ (°) within a range satisfying the formula (a) under a condition so that the total vapor deposition amount becomes 4 to 25 nm. In a case of continuously changing the angle θ^{R}₁ (°), it is preferred to change the angle towards a direction to reduce the angle.

The condition so that the vapor deposition amount becomes 4 to 25 nm, means a condition so that the thickness t of a metal layer formed on a surface of a region where no ridge is formed (flat plate portion) by vapor-depositing a metal or a metal compound becomes 4 to 25 nm, at a time of forming the metal layer on each ridge.

Here, with respect to condition-setting of the condition of vapor deposition amount, it is possible to use a method of vapor-depositing a metal or a metal compound for forming a predetermined metal layer on a flat portion of a light-transmitting substrate for condition-setting prepared separately, from a predetermined direction, and finding a vapor deposition condition providing a predetermined thickness on the flat portion.

### (Formation of Upper Layer of First Metal Layer)

The upper layer 22 of the first metal layer can be formed by carrying out, after the step (1R1), as shown in FIG. 4, a step (1R2) of vapor-depositing a metal or a metal compound from a direction of V1 substantially perpendicular to the longitudinal direction L of each ridge 12 and at an angle θ^{R}₂ (°) satisfying the following formula (b) on the first side surface 16 side to the height direction H of the ridge 12 under a condition so that the vapor deposition amount becomes larger than that of the step (1R1).

θ^{R}₁+3≦θ^{R}₂≦θ^{R}₁30 (b)

The angle θ^{R}₂ (°) preferably satisfies an inequation θ^{R}₁+6≦θ^{R}₂≦θ^{R}₁+25, more preferably satisfies an inequation θ^{R}₁+10≦θ^{R}₂≦θ^{R}₁+20.

The vapor deposition is preferably carried out under a condition so that the vapor deposition amount becomes larger than that of the step (1R1) and the vapor deposition amount becomes 25 to 70 nm, more preferably carried out under a condition so that the vapor deposition amount becomes 30 to 60 nm. It is also possible to carry out vapor deposition while continuously changing the angle θ^{R}₂ (°) within a range satisfying the formula (b) under a condition so that the total vapor deposition amount becomes 25 to 70 nm. In the case of continuously changing the angle θ^{R}₂ (°), it is preferred to change the angle in a direction of reducing the angle.

### [Process for Producing Wire-Grid Polarizer of Second Embodiment]

A wire-grid polarizer 10 of the second embodiment can be produced by carrying out the following step in addition to the production process of the first embodiment.

A step (1L1) of forming a second metal layer 25 on a second side surface 18 of each ridge 12 of the light-transmitting substrate 14 at an optional stage.

This step is preferably carried out between the step (1R1) and the step (1R2).

In the second embodiment, explanations of steps for forming the same constructions as those of the wire-grid polarizer 10 of the first embodiment are omitted.

### (Formation of Second Metal Layer)

The second metal layer 25 is, as shown in FIG. 4, preferably formed by carrying out a step (1L1) of vapor-depositing a metal or a metal compound from a direction V2 substantially perpendicular to the longitudinal direction L of each ridge 12 and at an angle θL₁ (°) satisfying the following formula (g) on the second side surface 18 side to the height direction H of the ridge 12.

tan(θ^{L}₁±10)=(Pp−Dpb/2)/Hp (g)

The angle θ^{L}₁ (°) preferably satisfies an equation tan(θ^{L}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. The vapor deposition may be carried out while continuously changing the angle θ^{L}₁ (°) within a range satisfying the formula (g) under a condition so that the total vapor deposition amount becomes 4 to 25 nm.

### [Process for Producing Wire-Grid Polarizer of Third Embodiment]

A wire-grid polarizer 10 of the third embodiment can be produced by carrying out a step (2R1) of forming a lower layer 21 of a first metal layer on a first side surface 16 of each ridge 12 of the light-transmitting substrate 14; a step (2L1) of forming a lower layer 26 of a second metal layer on a second side surface 18 of the ridge 12 of the light-transmitting substrate 14; after the step (2R1), a step (2R2) of forming an upper layer 22 of the first metal layer on a first side surface 16 of the ridge 12 and/or on a surface of the lower layer 21 of the first metal layer; and after the step (2L1), a step (2L2) of forming an upper layer 27 of the second metal layer on a second side surface 18 of the ridge 12 and/or on a surface of the lower layer 26 of the second metal layer. The order of these steps is preferably the step (2R1), the step (2L1), the step (2R2) and the step (2L2), but it may be the step (2R1), the step (2R2), the step (2L1) and the step (2L2), or it may be a step (2R1), the step (2L1), the step (2L2) and the step (2R2).

In the third embodiment, explanations of steps for forming the same constructions as those of the wire-grid polarizer 10 of the first and second embodiments are omitted.

### (Formation of Lower Layer of First Metal Layer)

A lower layer 21 of the first metal layer can be formed, as shown in FIG. 4, by carrying out a step (2R1) of vapor-depositing a metal or a metal compound from a direction V1 substantially perpendicular to the longitudinal direction L of each ridge 12 and at an angle θ^{R}₁ (°) satisfying the following formula (c) on the first side surface 16 side to the height direction H of the ridge 12.

tan(θ^{R}₁±10)=(Pp−Dpb/2)/Hp (c)

The angle θ^{R}₁ (°) preferably satisfies an equation tan(θ^{R}₁±7)=(Pp−Dpb/2)/Hp, more preferably satisfies an equation tan(θ^{R}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. It is possible to carry out the vapor deposition while continuously changing the angle θ^{R}₁ (°) within a range satisfying the formula (c) under a condition so that the total vapor deposition amount becomes 4 to 25 nm. In the case of continuously changing the angle θ^{R}₁ (°), it is preferred to change the angle in a direction of reducing the angle.

### (Formation of Lower Layer of Second Metal Layer)

A lower layer 26 of the second metal layer can be formed, as shown in FIG. 4, by carrying out a step (2L1) of vapor-depositing a metal or a metal compound from a direction V2 substantially perpendicular to the longitudinal direction L of each ridge 12 and at an angle θ^{L}₁ (°) satisfying the following formula (d) on the second side surface 18 side to the height direction H of the ridge 12.

tan(θ^{L}₁±10)=(Pp−Dpb/2)/Hp (d)

The angle θ^{L}₁ (°) preferably satisfies an equation tan(θ^{L}₁±7)=(Pp−Dpb/2)/Hp, more preferably satisfies an equation tan(θ^{L}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. It is possible to carry out the vapor deposition while continuously changing the angle θ^{L}₁ (°) within a range satisfying the formula (d) under a condition so that the total vapor deposition amount becomes 4 to 25 nm. In the case of carrying out the step (2L1) after the step (2R1) and continuously changing the angle θ^{L}₁ (°), it is preferred to change the angle in a direction of increasing the angle.

### (Formation of Upper Layer of First Metal Layer)

An upper layer 22 of the first metal layer can be formed, as shown in FIG. 4, by carrying out, after the step (2R1), a step (2R2) of vapor-depositing a metal or a metal compound from a direction V1 substantially perpendicular to the longitudinal direction L of each ridge 12 and at an angle θ^{R}₂ (°) satisfying the following formula (e) on the first side surface 16 side to the height direction H of the ridge 12 under a condition so that the vapor deposition amount becomes larger than that of the step (2R1).

θ^{R}₁+3≦θ^{R}₂≦θ^{R}₁+20 (e)

The angle θ^{R}₂ (°) preferably satisfies an inequation θ^{R}₁+8≦θ^{R}₂≦θ^{R}₁+18, more preferably satisfies an inequation θ^{R}₁+10≦θ^{R}₂≦θ^{R}₁+15.

The vapor deposition is preferably carried out under a condition so that the vapor deposition amount becomes larger than that of the step (2R1) and the vapor deposition amount becomes 10 to 50 nm, more preferably carried out under a condition so that the vapor deposition amount becomes 10 to 35 nm, still more preferably carried out under a condition so that the vapor deposition amount becomes 10 to 25 nm, particularly preferably carried out under a condition so that the vapor deposition amount becomes 15 to 20 nm. The vapor deposition may be carried out while continuously changing the angle θ^{R}₂ (°) within a range satisfying the formula (e) under a condition so that the total vapor deposition amount becomes 10 to 25 nm. In the case of carrying out the step (2L2) to be described later after the step (2R2) and continuously changing the angle θ^{R}₂ (°), it is preferred to change the angle in a direction of reducing the angle.

### (Formation of Upper Layer of Second Metal Layer)

An upper layer 27 of the second metal layer can be formed, as shown in FIG. 4, by carrying out, after the step (2L1), a step (2L2) of vapor-depositing a metal or a metal compound from a direction V2 substantially perpendicular to the longitudinal direction L of each ridge 12 and at an angle θ^{L}₂ (°) satisfying the following formula (f) on the second side surface 18 side to the height direction H of the ridge 12 under a condition so that the vapor deposition amount becomes larger than that of the step (2L1).

θ^{L}₁+1≦θ^{L}₂≦θ^{L}₁+20 (f)

The angle θ^{L}₂ (°) preferably satisfies an inequation θ^{L}₁+3≦θ^{L}₂≦θ^{L}₁+18, more preferably satisfies an inequation θ^{L}₁+5≦θ^{L}₂≦θ^{L}₁+15.

The vapor deposition is preferably carried out under a condition so that the vapor deposition amount becomes larger than that of the step (2L1) and the vapor deposition amount becomes 10 to 50 nm, more preferably carried out under a condition so that the vapor deposition amount becomes 10 to 35 nm, still more preferably carried out under a condition so that the vapor deposition amount becomes 10 to 25 nm, particularly preferably carried out under a condition so that the vapor deposition amount becomes 15 to 20 nm. The vapor deposition may be carried out while continuously changing the angle θ¹₂ (°) within a range satisfying the formula (f) under a condition so that the total vapor deposition amount becomes 10 to 25 nm. In the case of carrying out the step (2L2) to be described later after the step (2R2) and continuously changing the angle θ^{L}₂ (°), it is preferred to change the angle in a direction of increasing the angle.

The angle θ^{R} (θ^{L}) in the production processes of the first to third embodiments may, for example, be adjusted by employing the following vapor deposition apparatus.

A vapor deposition apparatus wherein the tilt of a light-transmitting substrate 14 disposed so as to face to a vapor deposition source can be adjusted so that the vapor deposition source is relatively positioned on an extension line in a direction V1 (V2) substantially perpendicular to the longitudinal direction of each ridge 12 and at an angle of θ^{R} (θ^{L}) on the first side surface 16 (second side surface 18) side to the height direction H of the ridge 12.

### EXAMPLES

Now, the present invention will be described in further detail with reference to Examples, but, the present invention is not limited to these Examples.

Examples 1 to 15 and 21 to 36 are Examples of the present invention, and Examples 16 to 20 and 37 are Comparative Examples.

### (Dimensions of Ridge and Layers)

Dimensions of the ridge and the layers were each obtained by measuring the dimension of the ridge or the dimension of the layer on the ridge with respect to five ridges in a transmission electron microscopic image of a cross-section of the wire-grid polarizer, and averaging the five dimensions.

(p-Polarized Light Transmittance)

p-Polarized light transmittance was measured by using an UV-VIS spectrophotometer (V-7200 manufactured by JASCO Corporation). The measurement was carried out by setting a polarizer as an accessory of the instrument, between a light source and a wire-grid polarizer so that its absorptance axis becomes parallel with the longitudinal direction of fine metal wires of the wire-grid polarizer, and making a polarized light incident from a front surface side (a side on which ridges are formed) or a rear surface side (side on which no ridge is formed) of the wire-grid polarizer. Measurement wavelengths were 450 nm, 550 nm and 700 nm.

A sample showing a p-polarized light transmittance of at least 70% is designated as S, a sample showing that of at least 60% and less than 70% is designated as A, a sample showing that of at least 50% and less than 60% is designated as B, and a sample showing that of less than 50% is designated as X.

(s-Polarized Light Reflectance)

s-Polarized light reflectance was measured by using an UV-VIS spectrophotometer (V-7200 manufactured by JASCO Corporation). The measurement was carried out by setting a polarizer as an accessory of the instrument, between a light source and a wire-grid polarizer so that its absorptance axis becomes perpendicular to the longitudinal direction of fine metal wires of the wire-grid polarizer, and making a polarized light incident at an angle of 5° to the front surface or the rear surface of the wire-grid polarizer. The measurement wavelengths were 450 nm, 550 nm and 700 nm.

A sample showing a front surface s-polarized light reflectance of at least 80% is designated as S, and a sample showing that of at least 70% and less than 80% is designated as A.

Further, a sample showing a rear surface s-polarized light reflectance of less than 20% is designated as S, a sample showing that of at least 20% and less than 40% is designated as A, a sample showing that of at least 40% and less than 50% is designated as B, and a sample showing that of at least 50% is designated as X.

### (Degree of Polarization)

The degree of polarization was calculated according to the following formula.

Degree of polarization=((Tp−Ts)/(Tp+Ts))^{0.5}×100

wherein Tp is a front surface p-polarized light transmittance and Ts is a front surface s-polarized light transmittance.

A sample showing a degree of polarization of at least 99.5% is designated as 5, a sample showing that of at least 99.0% and less than 99.5% is designated as A, a sample showing that of at least 98.0% and less than 99.0% is designated as B, and a sample showing that of less than 98.0% is designated as X.

### (Brightness)

Brightness was measured by the following method.

On an LED side light type backlight of 2 inch size, a wire-grid polarizer and a liquid crystal cell were piled in this order. The wire-grid polarizer was disposed so that its rear surface side faces to the liquid crystal cell. As the liquid crystal cell, one whose only upper side was provided with an iodine type polarizer was employed.

In a dark room, the backlight and the liquid crystal cell were turned on. The entire screen of the liquid crystal cell was turned to be white, and 10 minutes after the turning on, the center brightness B31 was measured by using a luminance colorimeter (BM-5AS manufactured by TOPCON CORPORATION) with a view angle of 0.1°, Subsequently, the entire screen of the liquid crystal cell was turned to be black, and a brightness B32 in this state was measured.

By using the same backlight, on the backlight, a liquid crystal cell having upper and lower surfaces provided with respective iodine type polarizers was overlapped. In a dark room, the backlight and the liquid crystal cell were turned on, and a center brightness B21 in a state that the entire screen of the liquid crystal cell was turned to be white, was measured in the same manner.

By using the values obtained in the above measurements, a brightness improvement ratio was obtained according to the following formula.

Brightness improvement ratio=(B31−B21)/B21×100

A sample showing a brightness improvement ratio of at least 25% is designated as S, a sample showing that of at least 20% and less than 25% is designated as A, a sample showing that of at least 15% and less than 20% is designated as B, and a sample showing that of less than 15% is designated as X.

### (Contrast)

By using the values obtained in the above measurements, the contrast was obtained according to the following formula.

Contrast=B31/B32

A sample showing a contrast of at least 500 is designated as S, a sample showing that of at least 300 and less than 500 is designated as A, a sample showing that of at least 100 and less than 300 is designated as B, and a sample showing that of less than 100 is designated as X.

### (Preparation of Photocurable Composition)

60 g of a monomer 1 (NK ester A-DPH, dipentaerythritol hexaacrylate, manufactured by Shin-Nakamura Chemical Co., Ltd.),

40 g of a monomer 2 (NK ester A-NPG, neopentyl glycol diacrylate, manufactured by Shin-Nakamura Chemical Co., Ltd.),

4.0 g of a photopolymerization initiator (IRGACURE 907, manufactured by Ciba Specialty Chemicals),

0.1 g of fluorosurfactant (cooligomer of fluoroacrylate (CH₂═CHCOO(CH₂)₂(CF₂)₈F) and butyl acrylate, manufactured by Asahi Glass Company, Limited, fluorine content: about 30 mass %, mass-average molecular weight: about 3,000),

1.0 g of a polymerization inhibitor (Q1301, manufactured by Wako Pure Chemical Industries, Ltd.) and

65.0 g of cyclohexanone, were put in a four-port flask of 1,000 mL to which a stirrer and a cooling pipe are attached.

In a state that inside of the flask was set at room temperature while light is shielded, stirring was carried out for 1 hour to homogenize the content. Subsequently, while the content of the flask was being stirred, 100 g of a colloidal silica (solid state content: 30 g) was gradually added, and the content of the flask was stirred for 1 hour in a state that inside of the flask was set to room temperature while light is shielded, to homogenize the content. Subsequently, 340 g of cyclohexanone was added, and the content of the flask was stirred for 1 hour in a state that inside of the flask was set to room temperature while light is shielded, to obtain a solution of photocurable composition 1.

### Example 1

### Preparation of Light-Transmitting Substrate

The photocurable composition 1 was applied on a surface of a high-transmitting polyethylene terephthalate (PET) film (Teijin Tetron O3, manufactured by Teijin DuPont, 100 mm×100 mm) having a thickness of 100 μm, by a spin coating method, to form a coating film of the photocurable composition 1 having a thickness of 5 μm.

A quartz mold (area: 150 mm×150 mm, pattern area: 100 mm×100 mm, groove pitch Pp: 140 nm, width of top portion of groove Dpb: 60 nm, width of bottom portion of groove Dpt: 20 nm, groove depth Hp: 200 nm, groove length: 100 mm, cross-sectional shape of groove: substantially trapezoidal shape) having a plurality of grooves formed so as to be parallel with one another at a predetermined pitch with flat portions formed between the grooves, was pressed against the coating film of the photocurable composition 1 at 25° C. with 0.5 MPa (gauge pressure) so that the grooves contact with the coating film of the photocurable composition 1.

While the state that the quartz mold as pressed against the coating film of the photocurable composition 1 was maintained, light of a high pressure mercury lamp (frequency: 1.5 kHz to 2.0 kHz, peak wavelengths: 255 nm, 315 nm and 365 nm, radiation energy at 365 nm: 1,000 mJ) was radiated to the photocurable composition 1 from the PET film side for 15 seconds, to cure the photocurable composition 1, and subsequently, the quartz mold was slowly separated from the light-transmitting substrate. By this method, a light-transmitting substrate 1 (ridge pitch Pp: 140 nm, width of bottom portion of ridge Dpb: 60 nm, width of top portion of ridge Dpt: 20 nm, ridge height Hp: 200 nm, θ1 and θ2: 84° having a plurality of ridges corresponding to the grooves of the quartz mold and flat portions between the ridges, was prepared.

### (Formation of Metal Layer)

Employing a vacuum vapor deposition apparatus (SEC-16CM, manufactured by Showa Shinku Co., Ltd.) wherein the tilt of a light-transmitting substrate 1 facing to a vapor deposition source can be adjusted, aluminum was vapor-deposited to cover the ridges of the light-transmitting substrate by an oblique vapor deposition method, to form the metal layer, thereby to obtain a wire-grid polarizer having a rear surface on which a PET film was pasted.

At this time, a first vapor deposition from a direction V1 (that is, from a first side surface side) substantially perpendicular to the longitudinal direction L of each ridge and at an angle θ^{R} on the first side surface side to the height direction H of the ridge, was carried out once with the angle θ^{R} and the thickness t shown in Table 1, and subsequently, a second vapor deposition from the direction V1 was carried out once with the angle θ^{R} and the thickness t shown in Table 1.

Here, the vapor deposition amount t is the thickness of a metal layer formed by the vapor deposition in a flat region wherein no ridge is formed, and the vapor deposition amount t was measured by a film thickness monitor employing a crystal oscillator as the film thickness sensor.

### Examples 2 to 9

After preparing a light-transmitting substrate in the same manner as Example 1, a wire-grid polarizer was obtained in the same manner as Example 1 except that the number of vapor depositions, the direction (V1 or V2) and the angle θ^{R} at each vapor deposition and the thickness t of the metal layer formed by each vapor deposition were set to be the angle and the thickness as shown in Table 1.

### Example 10

A light-transmitting substrate was prepared in the same manner as Example 1.

By employing the same vacuum vapor deposition apparatus as that of Example 1, aluminum was vapor-deposited on ridges of the light-transmitting substrate by an oblique vapor deposition method, to form a metal layer, thereby to obtain a wire-grid polarizer having a rear surface on which a PET film was pasted.

At this time, a first vapor deposition from a direction V1 (that is, from a first side surface side) substantially perpendicular to the longitudinal direction L of each ridge and at an angle θ^{R} on the first side surface side to the height direction H of the ridge was carried out once with the angle θ^{R} and the thickness t shown in Table 1, and subsequently, a second vapor deposition from a direction V2, (that is, the second side surface side) substantially perpendicular to the longitudinal direction L of each ridge and at an angle θ^{L} on the second side surface side to the height direction H of the ridge was carried out once with the angle θ^{R} and the thickness t shown in Table 1. Further, a third vapor deposition from the direction V1 was carried out once with the angle θ^{R} and the thickness t shown in Table 1.

### Example 11

A light-transmitting substrate was prepared in the same manner as Example 1.

By employing the same vacuum vapor deposition apparatus as that of Example 1, aluminum was vapor-deposited on ridges of the light-transmitting substrate by an oblique vapor deposition method, to form a metal layer, thereby to obtain a wire-grid polarizer having a rear surface on which a PET film was pasted.

At this time, a first vapor deposition from a direction V1 (that is, from a first side surface side) substantially perpendicular to the longitudinal direction L of each ridge and at an angle θ^{R} on the first side surface side to the height direction H of the ridge was carried out once with the angle θ^{R} and the thickness t shown in Table 1, and subsequently, a second vapor deposition from a direction V2, (that is, the second side surface side) substantially perpendicular to the longitudinal direction L of each ridge and at an angle θ^{L} on the second side surface side to the height direction H of the ridges was carried out once with the angle θ^{R} and the thickness t shown in Table 1. Further, a third vapor deposition from the direction V1 was carried out once with the angle θ^{R} and the thickness t shown in Table 1, and subsequently, a fourth vapor deposition from the direction V2 was carried out once with the angle θ^{L} and the thickness t shown in Table 1.

### Examples 12 to 15

After preparing a light-transmitting substrate in the same manner as Example 1, a wire-grid polarizer was obtained in the same manner as Example 1 except that the number of vapor deposition, the direction (V1 or V2) and the angle θ^{R} at each vapor deposition and the thickness t of the metal layer formed by each vapor deposition were set to be the angle and the thickness as shown in Table 1.

### Example 16

### Preparation of Light-Transmitting Substrate

A light-transmitting substrate (ridge pitch Pp: 215 nm, ridge width Dpb: 110 nm, ridge height Hp: 150 nm) having a plurality of ridges corresponding to grooves of a silicon mold, was prepared in the same manner as Example 1 except that the silicon mold (area: 20 mm×20 mm, pattern area: 10 mm×10 mm, groove pitch Pp: 215 nm, groove width Dpb: 110 nm, groove depth Hp: 150 nm, groove length: 10 mm, cross-sectional shape of groove: substantially isosceles triangle) having a plurality of grooves formed so as to be parallel with one another at a predetermined pitch was employed as a mold.

### (Formation of Metal Layer)

A wire-grid polarizer was obtained in the same manner as Example 1 except that the number of vapor depositions, the direction and the angle θ^{R} (or angle θ^{L}) at each vapor deposition and the thickness t of a metal layer formed by each vapor deposition were set to be the angle and the thickness shown in Table 1.

### Example 17

### (Preparation of Light-Transmitting Substrate)

A light-transmitting substrate (ridge pitch Pp: 130 nm, ridge width Dpb: 63 nm, ridge height Hp: 15 nm) having a plurality of ridges corresponding to grooves of a silicon mold, was prepared in the same manner as Example 1 except that the silicon mold (area: 20 mm×20 mm, pattern area: 10 mm×10 mm, groove pitch Pp: 130 nm, groove width Dpb: 63 nm, groove depth Hp: 15 nm, groove length: 10 mm, cross-sectional shape of groove: substantially isosceles triangle) having a plurality of grooves formed so as to be parallel with one another at a predetermined pitch was employed as a mold.

### (Formation of Metal Layer)

A wire-grid polarizer was obtained in the same manner as Example 1 except that the number of vapor depositions, the direction and the angle θ^{R} (or angle θ^{L}) at each vapor deposition and the thickness t of a metal layer formed by each vapor deposition were set to be the angle and the thickness shown in Table 1.

### Example 18

After preparing a light-transmitting substrate in the same manner as Example 17, a wire-grid polarizer was obtained in the same manner as Example 1 except that the number of vapor depositions, the direction and the angle θ^{R} in each vapor deposition and the thickness t of the metal layer formed by each vapor deposition were set to be the angle and the thickness as shown in Table 1.

### Example 19

A light-transmitting substrate (ridge pitch Pp: 200 nm, ridge bottom width Dpb: 65 nm, ridge top width Dpt: 50 nm, ridge height Hp: 100 nm) having a plurality of ridges corresponding to grooves of a nickel mold, was prepared in the same manner as Example 1 except that the nickel mold (area: 20 mm×20 mm, pattern area: 10 mm×10 mm, groove pitch Pp: 200 nm, groove top width Dpb: 65 nm, groove bottom width Dpt: 50 nm, groove depth Hp: 100 nm, groove length: 10 mm, cross-sectional shape of groove: substantially trapezoid) having a plurality of grooves formed so as to be parallel with one another at a predetermined pitch was employed as a mold.

### (Formation of Metal Layer)

A wire-grid polarizer was obtained in the same manner as Example 1 except that the number of vapor depositions, the direction and the angle θ^{R} in each vapor deposition and the thickness t of a metal layer formed by each vapor deposition were set to be the angle and the thickness shown in Table 1.

### Example 20

A light-transmitting substrate (ridge pitch Pp: 200 nm, ridge bottom width Dpb: 80 nm, ridge top width Dpt: 50 nm, ridge height Hp: 200 nm) having a plurality of ridges corresponding to grooves of a nickel mold, was prepared in the same manner as Example 1 except that the nickel mold (area: 20 mm×20 mm, pattern area: 10 mm×10 mm, groove pitch Pp: 200 nm, groove top width Dpb: 80 nm, groove bottom width Dpt: 50 nm, groove depth Hp: 200 nm, groove length: 10 mm, cross-sectional shape of groove: substantially trapezoid) having a plurality of grooves formed so as to be parallel with one another at a predetermined pitch was employed as a mold.

### (Formation of Metal Layer)

A wire-grid polarizer was obtained in the same manner as Example 1 except that the number of vapor depositions, the direction and the angle θ^{R} in each vapor deposition and the thickness t of a metal layer formed by each vapor deposition were set to be the angle and the thickness shown in Table 1.

### [Measurement and Evaluation]

With respect to the wire-grid polarizers of Examples 1 to 20, dimensions of the metal layer were measured. Table 2 shows the results.

Further, with respect to the wire-grid polarizers of Examples 1 to 20, the transmittance, the reflectance, the degree of polarization, the brightness and the contrast were measured. Table 3 shows the results.

TABLE 1

| | First vapor deposition | | | Second vapor deposition | | | Third vapor deposition | | | Fourth vapor deposition | | |
|---|---|---|---|---|---|---|---|---|---|---|---|---|
| | | | Vapor | | | Vapor | | | Vapor | | | Vapor |
| | | Angle | deposition | | Angle | deposition | | Angle | deposition | | Angle | deposition |
| | | θ^{R(L)} | amount t | | θ^{R(L)} | amount t | | θ^{R(L)} | amount t | | θ^{R(L)} | amount t |
| Ex. | Direction V | (°) | (nm) | Direction V | (°) | (nm) | Direction V | (°) | (nm) | Direction V | (°) | (nm) |
| 1 | V1 | 30 | 10 | V1 | 45 | 35 | — | — | — | — | — | — |
| 2 | V1 | 30 | 15 | V1 | 45 | 35 | — | — | — | — | — | — |
| 3 | V1 | 30 | 20 | V1 | 45 | 35 | — | — | — | — | — | — |
| 4 | V1 | 30 | 5 | V1 | 45 | 35 | — | — | — | — | — | — |
| 5 | V1 | 30 | 5 | V1 | 50 | 35 | — | — | — | — | — | — |
| 6 | V1 | 30 | 10 | V1 | 40 | 35 | — | — | — | — | — | — |
| 7 | V1 | 30 | 10 | V1 | 50 | 35 | — | — | — | — | — | — |
| 8 | V1 | 30 | 10 | V1 | 45 | 50 | — | — | — | — | — | — |
| 9 | V1 | 30 | 10 | V1 | 45 | 65 | — | — | — | — | — | — |
| 10 | V1 | 30 | 10 | V2 | 30 | 10 | V1 | 45 | 35 | — | — | — |
| 11 | V1 | 30 | 10 | V2 | 30 | 10 | V1 | 45 | 20 | V2 | 45 | 20 |
| 12 | V1 | 30 | 10 | V2 | 30 | 10 | V1 | 40 | 15 | V2 | 45 | 15 |
| 13 | V1 | 30 | 10 | V2 | 30 | 10 | V1 | 40 | 20 | V2 | 40 | 20 |
| 14 | V1 | 30 | 10 | V2 | 30 | 10 | V1 | 40 | 15 | V2 | 40 | 15 |
| 15 | V1 | 30 | 10 | V2 | 30 | 10 | V1 | 40 | 15 | V2 | 35 | 15 |
| 16 | V1 | 60 | 40 | V2 | 60 | 40 | — | — | — | — | — | — |
| 17 | V1 | 15 | 40 | V2 | — | — | — | — | — | — | — | — |
| 18 | V1 | 0 | 35 | V2 | — | — | — | — | — | — | — | — |
| 19 | V1 | 45 | 45 | V2 | — | — | — | — | — | — | — | — |
| 20 | V1 | 45 | 45 | V2 | — | — | — | — | — | — | — | — |

TABLE 2

| | | | | | Metal layer | | | | | | | |
|---|---|---|---|---|---|---|---|---|---|---|---|---|
| | Light-transmitting | | | | | | | | | | Second side | |
| | substrate | | | | First side surface | | | | | | surface | |
| | Pp | Dpb | Dpt | Hp | Da1 | Dr1 | H1 | H2 | H1/Hp | H2/Hp | Da2 | Dr2 |
| Ex. | (nm) | (nm) | (nm) | (nm) | (nm) | (nm) | (nm) | (nm) | (nm) | (nm) | (nm) | (nm) |
| 1 | 140 | 60 | 20 | 200 | 10 | 45 | 45 | 200 | 0.23 | 1 | — | — |
| 2 | 140 | 60 | 20 | 200 | 15 | 50 | 47 | 200 | 0.24 | 1 | — | — |
| 3 | 140 | 60 | 20 | 200 | 20 | 55 | 50 | 200 | 0.25 | 1 | — | — |
| 4 | 140 | 60 | 20 | 200 | 5 | 40 | 43 | 200 | 0.22 | 1 | — | — |
| 5 | 140 | 60 | 20 | 200 | 5 | 40 | 47 | 200 | 0.24 | 1 | — | — |
| 6 | 140 | 60 | 20 | 200 | 10 | 45 | 41 | 200 | 0.21 | 1 | — | — |
| 7 | 140 | 60 | 20 | 200 | 10 | 45 | 49 | 200 | 0.25 | 1 | — | — |
| 8 | 140 | 60 | 20 | 200 | 10 | 60 | 65 | 200 | 0.33 | 1 | — | — |
| 9 | 140 | 60 | 20 | 200 | 10 | 75 | 87 | 200 | 0.44 | 1 | — | — |
| 10 | 140 | 60 | 20 | 200 | 10 | 45 | 50 | 200 | 0.25 | 1 | 10 | — |
| 11 | 140 | 60 | 20 | 200 | 10 | 30 | 60 | 200 | 0.30 | 1 | 10 | 30 |
| 12 | 140 | 60 | 20 | 200 | 10 | 25 | 50 | 200 | 0.25 | 1 | 10 | 25 |
| 13 | 140 | 60 | 20 | 200 | 10 | 30 | 55 | 200 | 0.28 | 1 | 10 | 30 |
| 14 | 140 | 60 | 20 | 200 | 10 | 25 | 46 | 200 | 0.23 | 1 | 10 | 25 |
| 15 | 140 | 60 | 20 | 200 | 10 | 25 | 44 | 200 | 0.22 | 1 | 10 | 25 |

| | | | | | | | | | | |
|---|---|---|---|---|---|---|---|---|---|---|
| 16 | 215 | 110 | — | 150 | 35 | 10 | 60 | 0.07 | 0.4 | 35 |
| 17 | 130 | 63 | — | 15 | 18 | 390 | 10 | 26 | 0.67 | 17 |
| 18 | 130 | 63 | — | 15 | 35 | 250 | 10 | 16.67 | 0.67 | — |
| 19 | 200 | 65 | 50 | 100 | 70 | 10 | 50 | 0.1 | 0.5 | — |
| 20 | 200 | 80 | 50 | 200 | 70 | 10 | 50 | 0.05 | 0.25 | — |

TABLE 3

| | Wavelength | | | | | | | | | |
|---|---|---|---|---|---|---|---|---|---|---|
| | 450 nm | | | | | 550 nm | | | | |
| | p-Polarized light | | s-Polarized light | | | p-Polarized light | | s-Polarized light | | |
| | transmittance | | reflectance | | Degree | transmittance | | reflectance | | Degree |
| | Front | Rear | Front | Rear | of | Front | Rear | Front | Rear | of |
| Ex. | surface | surface | surface | surface | polarization | surface | surface | surface | surface | polarization |
| 1 | S | S | S | A | B | S | S | S | A | A |
| 2 | S | S | A | A | B | S | S | S | S | A |
| 3 | S | S | S | B | B | S | S | S | B | S |
| 4 | S | S | A | A | B | S | S | S | B | B |
| 5 | S | S | A | A | B | S | S | A | B | B |
| 6 | S | S | A | A | B | S | S | S | A | A |
| 7 | S | S | A | S | B | S | S | S | S | B |
| 8 | S | S | S | B | S | S | S | S | B | S |
| 9 | S | S | S | B | S | S | S | S | B | S |
| 10 | B | B | S | S | S | A | A | S | S | S |
| 11 | B | B | S | S | S | B | B | S | S | S |
| 12 | A | A | S | S | S | A | A | S | S | S |
| 13 | B | B | S | A | S | B | B | S | A | S |
| 14 | A | A | S | S | S | A | A | S | A | S |
| 15 | A | A | S | S | S | S | S | S | A | S |
| 16 | B | B | S | X | B | A | A | S | X | B |
| 17 | S | S | S | X | S | S | S | S | X | S |
| 18 | S | S | S | X | S | S | S | S | X | S |
| 19 | S | S | S | X | B | S | S | S | X | B |
| 20 | S | S | S | X | B | S | S | S | X | B |

Wavelength
700 nm

| | | | |
|---|---|---|---|
| p-Polarized light | s-Polarized light | | |
| transmittance | reflectance | Degree | Brightness |

| | Front | Rear | Front | Rear | of | improvement | |
|---|---|---|---|---|---|---|---|
| Ex. | surface | surface | surface | surface | polarization | ratio | Contrast |
| 1 | S | S | S | A | S | S | B |
| 2 | S | S | S | A | S | S | B |
| 3 | S | S | S | B | S | S | A |
| 4 | S | S | A | B | B | A | B |
| 5 | S | S | A | B | B | A | B |
| 6 | S | S | S | A | S | S | B |
| 7 | S | S | S | A | A | S | B |
| 8 | S | S | S | B | S | S | S |
| 9 | S | S | S | B | S | S | S |
| 10 | A | A | S | A | S | S | S |
| 11 | B | B | S | S | S | S | S |
| 12 | B | B | S | S | S | S | S |
| 13 | B | B | S | A | S | S | S |
| 14 | A | A | S | A | S | S | S |
| 15 | S | S | S | A | S | S | S |
| 16 | S | S | S | X | A | S | B |
| 17 | S | S | S | X | S | S | S |
| 18 | S | S | S | X | S | S | S |
| 19 | S | S | S | X | A | S | B |
| 20 | S | S | S | X | A | S | B |

In each of Examples 1 to 15, the wire-grid polarizer has a metal layer covering a side surface of each ridge having a substantially trapezoidal cross-section wherein the maximum value Da1 of the covering thickness in a region from a half-height position to the bottom portion of each ridge, is smaller than the maximum value Dr1 of the covering thickness in a region from the half-height position to the top portion of the ridge. Accordingly, the wire-grid polarizer shows a high degree of polarization, a high p-polarized light transmittance and a low rear surface s-polarized light reflectance.

Example 16 is an Example corresponding to Example 2 of Patent Document 2. Since the pitch is large and the covering thickness of the metal layer was uniform, the rear surface s-polarized light reflectance was high. Further, the degree of polarization was low.

Examples 17 and 18 are Examples corresponding to Examples 4 and 5 of Patent Document 3. Since the covering thickness of the metal layer was uniform, the rear surface s-polarized light reflectance was high.

Examples 19 and 20 are Examples corresponding to Examples 9 and 10 of Patent Document 4. Since the covering thickness of the metal layer was uniform, the rear surface s-polarized light reflectance was high. Further, the degree of polarization was low.

### Examples 21 to 24

A wire-grid polarizer was obtained in the same manner as Example 1 except that the light-transmitting substrate, the number of vapor depositions, the direction and the angle θ^{R} in each vapor deposition and the thickness t of a metal layer formed by each vapor deposition were set to be the light-transmitting substrate, the number, the angle and the thickness shown in Table 4.

### Example 25

A light-transmitting substrate was prepared in the same manner as Example 21.

By employing the same vacuum vapor deposition apparatus as that of Example 21, aluminum was vapor-deposited on ridges of the light-transmitting substrate by an oblique vapor deposition method, to form a metal layer, thereby to obtain a wire-grid polarizer having a rear surface on which a PET film was pasted.

At this time, a first vapor deposition from a direction V1 (that is, from a first side surface side) substantially perpendicular to the longitudinal direction L of each ridge and at an angle θ^{R} on the first side surface side to the height direction H of the ridge was carried out once with the angle θ^{R} and the thickness t shown in Table 4, and subsequently, a vapor deposition from a direction V2, (that is, the second side surface side) substantially perpendicular to the longitudinal direction L of the ridge and at an angle θ^{L} on the second side surface side to the height direction H of the ridge was carried out once with the angle θ^{R} and the thickness t shown in Table 4. Further, a second vapor deposition from the direction V1 was carried out once with the angle θ^{R} and the thickness t shown in Table 4, and subsequently, a third vapor deposition from the direction V2 was carried out once with the angle θ^{L} and the thickness t shown in Table 4.

### [Measurement and Evaluation]

With respect to the wire-grid polarizers of Examples 21 to 25, dimensions of the metal layer were measured. Table 4 shows the results.

Further, with respect to the wire-grid polarizers of Examples 21 to 25, the transmittance, the reflectance, the degree of polarization, the brightness and the contrast were measured. Table 5 shows the results.

TABLE 4

| | | | Ex. 21 | Ex. 22 | Ex. 23 | Ex. 24 | Ex. 25 |
|---|---|---|---|---|---|---|---|
| First vapor deposition | | Direction | V1 | V1 | V1 | V1 | V1 |
| | | Angle (°) | 20 | 20 | 20 | 20 | 20 |
| | | Vapor deposition amount (nm) | 15 | 15 | 15 | 15 | 15 |
| Second vapor deposition | | Direction | V1 | V1 | V1 | V1 | V2 |
| | | Angle (°) | 40 | 40 | 40 | 25 | 20 |
| | | Vapor deposition amount (nm) | 60 | 70 | 80 | 15 | 15 |
| Third vapor deposition | | Direction | — | — | — | V1 | V1 |
| | | Angle (°) | — | — | — | 40 | 25 |
| | | Vapor deposition amount (nm) | — | — | — | 35 | 25 |
| Fourth vapor deposition | | Direction | — | — | — | — | V2 |
| | | Angle (°) | — | — | — | — | 25 |
| | | Vapor deposition amount (nm) | — | — | — | — | 25 |
| Light-transmitting | | Pp (nm) | 160 | 160 | 160 | 120 | 160 |
| substrate | | Dpb (nm) | 80 | 80 | 80 | 60 | 80 |
| | | Dpt (nm) | 20 | 20 | 20 | 20 | 20 |
| | | Hp (nm) | 400 | 400 | 400 | 250 | 400 |
| Metal | First side | Da1 | 15 | 15 | 15 | 15 | 15 |
| layer | surface | Dr1 | 60 | 70 | 80 | 65 | 40 |
| | | Dr1/Da1 | 4.00 | 4.67 | 5.33 | 4.33 | 2.67 |
| | Second side | Da2 | — | — | — | — | 15 |
| | surface | Dr2 | — | — | — | — | 40 |
| | | Dr2/Da2 | — | — | — | — | 2.67 |

TABLE 5

| | | | | Ex. 21 | Ex. 22 | Ex. 23 | Ex. 24 | Ex. 25 |
|---|---|---|---|---|---|---|---|---|
| Optical | 450 nm | Tp | Front | A | A | A | A | B |
| characteristics | | | Rear | A | A | A | A | B |
| | | Rs | Front | S | S | S | S | A |
| | | | Rear | S | S | S | S | S |
| | | Degree of | | B | B | A | B | S |
| | | polarization | | | | | | |
| | 550 nm | Tp | Front | S | S | A | A | A |
| | | | Rear | S | S | A | A | A |
| | | Rs | Front | S | S | S | S | S |
| | | | Rear | S | S | S | S | S |
| | | Degree of | | A | A | S | A | S |
| | | polarization | | | | | | |
| | 700 nm | Tp | Front | S | S | S | S | A |
| | | | Rear | S | S | S | S | A |
| | | Rs | Front | A | S | A | S | A |
| | | | Rear | S | S | S | S | S |

| | | | | | |
|---|---|---|---|---|---|
| Degree of | S | S | S | S | S |
| polarization | | | | | |

| | | | | | |
|---|---|---|---|---|---|
| Brightness | S | S | S | S | S |
| improvement ratio | | | | | |
| Contrast | S | S | S | S | S |

Tp: p-polarized light transmittance,
Rs: s-polarized light reflectance.

### Examples 26 to 37

A wire-grid polarizer was obtained in the same manner as Examples 21 to 25 except that the light-transmitting substrate was changed to the light-transmitting substrate shown in Table 6 and the vapor deposition conditions were changed to conditions whereby the metal layer shown in Table 6 is formed.

### [Measurement and Evaluation]

With respect to the wire-grid polarizers shown in Examples 26 to 37, the transmittance, the reflectance and the degree of polarization were measured. Table 7 shows the results.

Here, with respect to the degree of polarization, a sample showing that of at least 99.95% was designated as S, a sample showing that of at least 99.9% and less than 99.95% was designated as A, a sample showing that of at least 99.5% and less than 99.9% was designated as B, and a sample showing that of less than 99.5% was designated as X.

TABLE 6

| | | | Ex. | | | | | | | | | | | |
|---|---|---|---|---|---|---|---|---|---|---|---|---|---|---|
| | | | 26 | 27 | 28 | 29 | 30 | 31 | 32 | 33 | 34 | 35 | 36 | 37 |
| Light-transmitting | | Pp | 120 | 120 | 120 | 120 | 120 | 120 | 120 | 120 | 120 | 120 | 120 | 150 |
| substrate | | Dpb | 60 | 60 | 60 | 60 | 60 | 60 | 60 | 60 | 60 | 60 | 60 | 75 |
| | | Dpt | 20 | 20 | 20 | 20 | 20 | 20 | 20 | 20 | 20 | 20 | 20 | 75 |
| | | Hp | 280 | 280 | 280 | 330 | 380 | 430 | 500 | 280 | 280 | 280 | 280 | 200 |
| Metal | First side | Da1 | 10 | 10 | 10 | 10 | 10 | 10 | 10 | 10 | 5 | 5 | 5 | 5 |
| layer | surface | Dr1 | 35 | 40 | 45 | 35 | 35 | 35 | 35 | 20 | 20 | 25 | 35 | 5 |
| | | Dr1/Da1 | 3.50 | 4.00 | 4.51 | 3.50 | 3.50 | 3.50 | 3.51 | 2.00 | 4.00 | 5.00 | 7.00 | 1.00 |
| | | H1 | 55 | 65 | 76 | 64 | 74 | 84 | 98 | 54 | 76 | 41 | 62 | 36 |
| | | H2 | 280 | 280 | 280 | 330 | 380 | 430 | 500 | 280 | 280 | 280 | 280 | 200 |
| | | H1/Hp | 0.19 | 0.23 | 0.27 | 0.19 | 0.19 | 0.19 | 0.20 | 0.19 | 0.27 | 0.15 | 0.22 | 0.18 |
| | | H2/Hp | 1 | 1 | 1 | 1 | 1 | 1 | 1 | 1 | 1 | 1 | 1 | 1 |
| | Second | Da2 | — | — | — | — | — | — | — | 10 | 5 | — | — | 5 |
| | side | Dr2 | — | — | — | — | — | — | — | 20 | 20 | — | — | 5 |
| | surface | Dr1/Da1 | 3.50 | 4.00 | 4.51 | 3.50 | 3.50 | 3.50 | 3.51 | 2.00 | 4.00 | 5.00 | 7.00 | 1.00 |

TABLE 7

| | | | | Ex. | | | | | | | | | | | |
|---|---|---|---|---|---|---|---|---|---|---|---|---|---|---|---|
| | | | | 26 | 27 | 28 | 29 | 30 | 31 | 32 | 33 | 34 | 35 | 36 | 37 |
| Optical | 450 nm | Tp | Front | S | S | A | S | S | S | S | B | B | A | A | S |
| characteristics | | | Rear | S | S | A | S | S | S | S | B | B | A | A | S |
| | | Rs | Front | S | S | S | S | S | S | S | S | S | S | S | S |
| | | | Rear | S | S | S | S | S | S | S | S | S | S | S | B |
| | | Degree of | | S | S | S | S | S | S | S | S | S | A | A | X |
| | | polarization | | | | | | | | | | | | | |
| | 550 nm | Tp | Front | S | S | S | S | S | S | S | A | A | S | S | A |
| | | | Rear | S | S | S | S | S | S | S | A | A | S | S | S |
| | | Rs | Front | S | S | S | S | S | S | S | S | S | S | S | S |
| | | | Rear | S | S | S | S | S | S | S | S | S | S | S | X |
| | | Degree of | | S | S | S | S | S | S | S | S | S | S | S | B |
| | | polarization | | | | | | | | | | | | | |
| | 700 nm | Tp | Front | S | S | S | S | S | S | S | B | B | S | S | A |
| | | | Rear | A | S | A | S | S | S | S | B | B | S | S | A |
| | | Rs | Front | S | S | S | S | S | S | S | S | S | S | S | S |
| | | | Rear | S | S | S | S | S | S | S | S | S | S | S | X |

| | | | | | | | | | | | | |
|---|---|---|---|---|---|---|---|---|---|---|---|---|
| Degree of | S | S | S | S | S | S | S | S | S | S | S | A |
| polarization | | | | | | | | | | | | |

Tp: p-polarized light transmittance,
Rs: s-polarized light reflectance.

### INDUSTRIAL APPLICABILITY

The wire-grid polarizer of the present invention is useful as a polarizer for image display devices such as liquid crystal display devices, rear projection TVs or front projectors.

This application is a continuation of PCT Application No. PCT/JP2010/067687, filed Oct. 7, 2010, which is based upon and claims the benefit of priority from Japanese Patent Application No. 2009-234431 filed on Oct. 8, 2009. The contents of those applications are incorporated herein by reference in its entirety.

### REFERENCE SYMBOLS

10: wire-grid polarizer, 12: ridge, 13: flat portion, 14: light-transmitting substrate,
16: first side surface, 18: second side surface, 19: top portion,
20: first metal layer, 21: lower layer of first metal layer, 22: upper layer of first metal layer
25: second metal layer, 26: lower layer of second metal layer, 27: upper layer of second metal layer

What is claimed is:

1. A wire-grid polarizer comprising:
a light-transmitting substrate having a surface on which a plurality of ridges are formed in parallel with one another at a predetermined pitch with flat portions formed between the ridges, each of the ridges having a width narrowing from the bottom portion toward the top portion; and
a metal layer comprising a metal or a metal compound and covering at least one side surface of each ridge extending along the longitudinal direction of the ridge, the maximum value of the covering thickness of the metal layer in a region from a half-height position to the bottom portion of the ridge being smaller than the maximum value of the covering thickness of the metal layer in a region from the half-height position to the top portion of the ridge.

2. The wire-grid polarizer according to claim 1, which comprises a metal layer comprising a metal or a metal compound and covering two side surfaces of each ridge extending along the longitudinal direction of the ridge, the maximum value of the covering thickness of the metal layer in a region from the half-height position to the bottom portion of each ridge being smaller than the maximum value of the covering thickness of the metal layer in a region from the half-height position to the top portion of the ridge in each of the two side surfaces.

3. The wire-grid polarizer according to claim 1, wherein the cross-sectional shape of each ridge along a section perpendicular to the longitudinal direction is a triangle or a trapezoid.

4. The wire-grid polarizer according to claim 1, wherein provided that the maximum value of the covering thickness of the metal layer in a region from the half-height position to the bottom portion of each ridge is Da1 and the maximum value of the covering thickness of the metal layer in a region from the half-height position to the top portion of the ridge is Dr1, then, a relation Dr1>Da1 is satisfied, Dr1 is from 20 to 80 nm and Da1 is from 4 to 25 nm.

5. The wire-grid polarizer according to claim 4, wherein Dr1/Da1 is from 2.5 to 10.

6. The wire-grid polarizer according to claim 2, wherein provided that the maximum values of the covering thicknesses of the metal layers on respective two side surfaces of each ridge extending along the longitudinal direction of the ridge, each of which covers a region from the half-height position to the bottom portion of each ridge, are Da1 and Da2, and that the maximum values of the covering thicknesses of the metal layers on the two respective side surfaces, each of which covers a region from the half-height position to the top portion of the ridge, are Dr1 and Dr2, then, relations Dr1>Da1 and Dr2>Da2 are satisfied, Dr1 is from 10 to 45 nm, Dr2 is from 10 to 45 nm, Da1 is from 4 to 25 nm and Da2 is from 4 to 25 nm.

7. The wire-grid polarizer according to claim 6, wherein Dr1/Da1 is from 1.5 to 6 and Dr2/Da2 is from 1.5 to 6.

8. A process for producing a wire-grid polarizer comprising a light-transmitting substrate having a surface on which a plurality of ridges are formed in parallel with one another at a predetermined pitch with flat portions formed between the ridges, each of the ridges having a width narrowing from the bottom portion toward the top portion; and a metal layer comprising a metal or a metal compound and covering at least one side surface of each ridge extending along the longitudinal direction of the ridge;
the process comprising a step (1R1) of carrying out vapor deposition of a metal or a metal compound from a direction substantially perpendicular to the longitudinal direction of each ridge and at an angle θ^{R}₁ (°) satisfying the following formula (a) on a first side surface side to the height direction of the ridge; and
a step (1R2) after the step (1R1), of carrying out vapor deposition of the metal or the metal compound from a direction substantially perpendicular to the longitudinal direction of each ridge and at an angle θ^{R}₂ (°) satisfying the following formula (b) on the first side surface side to the height direction of the ridge under a condition so that the vapor deposition amount becomes larger than that of the step (1R1), to form the metal layer:
tan(θ^{R}₁±10)=(Pp−Dpb/2)/Hp (a)
θ^{R}₁+3≦θ^{R}₂≦θ^{R}₁+30 (b)
where Pp is the pitch of the ridges, Dpb is the width of the bottom portion of each ridge, and Hp is the height of each ridge in formula (a).

9. The process for producing a wire-grid polarizer according to claim 8, having a metal layer comprising a metal or a metal compound and covering two side surfaces of each ridge extending along the longitudinal direction of the ridge, the process comprising:
a step (2R1) of carrying out vapor deposition of the metal or the metal compound from a direction substantially perpendicular to the longitudinal direction of each ridge and at an angle θ^{R}₁ (°) satisfying the following formula (c) on the first side surface side to the height direction of the ridge;
a step (2L1) of carrying out vapor deposition of the metal or the metal compound from a direction substantially perpendicular to the longitudinal direction of the ridge and at an angle θ^{L}₁ (°) satisfying the following formula (d) on the second side surface side to the height direction of the ridge;
a step (2R2) after the step (2R1), of carrying out vapor deposition of the metal or the metal compound from a direction substantially perpendicular to the longitudinal direction of the ridge and at an angle θ^{R}₂ (°) satisfying the following formula (e) on the first side surface side to the height direction of the ridge under a condition so that the vapor deposition amount becomes larger than that of the step (2R1); and
a step (2L2) after the step (2L1), of carrying out vapor deposition of the metal or the metal compound from a direction substantially perpendicular to the longitudinal direction of the ridge and at an angle θ^{L}₂ (°) satisfying the following formula (f) on the second side surface side to the height direction of the ridge under a condition so that the vapor deposition amount becomes larger than that of the step (2L1), to form the metal layer:
tan(θ^{R}₁±10)=(Pp−Dpb/2)/Hp (c)
tan(θ^{L}₁±10)=(Pp−Dpb/2)/Hp (d)
θ^{R}₁+3≦θ^{R}₂≦θ^{R}₁+20 (e)
θ^{L}₁+1≦θ^{L}₂≦θ^{L}₁+20 (f)
where Pp is the pitch of the ridges, Dpb is the width of the bottom portion of each ridge, and Hp is the height of each ridge in formulae (c) and (d).

10. The process for producing a wire-grid polarizer according to claim 8, wherein the step (1R1) is carried out under a condition whereby the vapor deposition amount becomes 4 to 25 nm, and the step (1R2) is carried out under a condition whereby the vapor deposition amount becomes 25 to 70 nm.

11. The process for producing a wire-grid polarizer according to claim 9, wherein the step (2R1) and the step (2L1) are carried out under conditions whereby the vapor deposition amounts become 4 to 25 nm, and the step (2R2) and the step (2L2) are carried out under conditions whereby the vapor deposition amounts become 10 to 25 nm.

12. The process for producing a wire-grid polarizer according to claim 8, wherein each ridge comprises a photocurable resin or a thermoplastic resin and is formed by an imprint method.
